(19) United States
(12) Patent Application Publication
(10) Pub. No.: US 2026/0290185 A1
(43) Pub. Date: Sep. 24, 2026

(54) SYSTEM

(71) Applicant: SoftBank Group Corp., Tokyo (JP)

(72) Inventor: Shigeya MORISHITA, Tokyo (JP)

(73) Assignee: SoftBank Group Corp., Tokyo (JP)

(21) Appl. No.: 19/555,917

(22) Filed: Mar. 4, 2026

(30) Foreign Application Priority Data
Mar. 19, 2025 (JP) 2025-044477

(51) Int. Cl. G09B 5/06; G06F 40/284; G06F 40/40; G06N 3/0455; G06N 3/0475; G06T 11/26; G06V 10/764; G06V 40/16

(52) U.S. Cl. CPC G09B 5/06; G06F 40/40; G06N 3/0455; G06N 3/0475; G06T 11/26; G06F 40/284; G06V 10/764; G06V 40/171; G06V 40/174

(57) ABSTRACT

A system includes a processor that is configured to receive, as input, basic personal information of a user including at least a target body image, an age, a sex, and a weight, and activity information that varies on a daily basis including at least diet information, sleep information, exercise information, and emotional state information, and store the received information in a database, analyze the stored information by using a generative AI model, analyze a health condition of the user based on a result of the analysis, and generate a prompt sentence that instructs the generative AI model to propose an action for leading the health condition of the user toward a healthy state, and analyze the emotional state information by using an emotion engine in order to recognize an emotion of the user, and provide advice corresponding to the recognized emotion.

### CROSS-REFERENCE TO RELATED APPLICATION

This application is based on and claims priority under 35 USC 119 from Japanese Patent Application No. 2025-044477 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional healthcare support systems generally provide uniform advice based on limited parameters such as body weight, age, and simple activity logs, and therefore fail to generate sufficiently personalized guidance that reflects a user's fluctuating daily conditions, emotional states, and individual goals. In particular, such systems are not configured to integrate basic personal information with rich, time-varying activity information, including diet, sleep, exercise, and emotional state, and thus cannot deliver context-aware advice tailored to the user's current physical and psychological condition. Furthermore, existing systems typically do not utilize generative AI models through specifically designed prompt sentences, and therefore cannot flexibly generate nuanced behavioral proposals in response to complex and changing user situations. In addition, conventional systems often ignore the user's emotional state, or treat it only superficially, and as a result, the advice they provide may not be psychologically acceptable or motivating to the user, which reduces adherence to recommended actions. Accordingly, there is a need for a healthcare coaching system that stores and analyzes both static and dynamic user information, leverages a generative AI model via appropriate prompts, recognizes the user's emotional state by an emotion engine, and provides comprehensive, emotionally adaptive advice that encourages the user to take actions leading toward a healthier state.

### SUMMARY

In order to solve the above-described problems, an embodiment of the present invention provides a system comprising a processor, wherein the processor is configured to receive, as input, basic personal information of a user including at least a target body image, an age, a sex, and a weight, and activity information that varies on a daily basis including at least diet information, sleep information, exercise information, and emotional state information, and to store the received information in a database. The processor is further configured to analyze the stored information by using a generative AI model, analyze a health condition of the user based on a result of the analysis, and generate a prompt sentence that instructs the generative AI model to propose an action for leading the health condition of the user toward a healthy state. In addition, the processor is configured to analyze the emotional state information by using an emotion engine in order to recognize an emotion of the user, and to provide advice corresponding to the recognized emotion. In one aspect, the processor is configured, when a sleep time of the user is short, to generate a prompt sentence that instructs the generative AI model to propose a diet for suppressing increased appetite, thereby enabling personalized dietary guidance according to sleep status. In another aspect, the processor is configured to analyze the activity information of the user and to generate a prompt sentence that instructs the generative AI model to propose an appropriate amount and type of exercise, thereby enabling individualized exercise recommendations that match the user's current activity level and target body image.

The term “basic personal information” refers to information that characterizes a relatively static profile of a user, including at least a target body image, an age, a sex, and a weight, and optionally further attributes such as height, medical history, lifestyle preferences, and health goals.

The term “target body image” refers to a user-defined goal or desired physical state, such as a target body weight, body fat percentage, muscle mass, body shape, or other appearance- or physique-related objective that the user intends to achieve or maintain.

The term “activity information” refers to information that varies on a daily or time-varying basis and reflects a user's lifestyle and behaviors, including at least diet information, sleep information, exercise information, and emotional state information, and optionally further parameters such as stress level, work schedule, and daily steps.

The term “diet information” refers to data describing the user's food and beverage intake, including, for example, types of foods, portion sizes, meal times, nutritional content, and eating patterns over a given period.

The term “sleep information” refers to data describing the user's sleep-related behavior, including, for example, total sleep time, sleep onset and wake-up times, sleep quality indicators, and occurrences of nap or fragmented sleep.

The term “exercise information” refers to data describing the user's physical activity, including, for example, exercise type, intensity, duration, frequency, and, where available, related metrics such as distance, heart rate, or energy expenditure.

The term “emotional state information” refers to data representing or derived from the user's emotional condition, including, for example, self-reported mood, stress or anxiety levels, and emotions inferred from text, voice, physiological signals, or other sensor inputs.

The term “database” refers to any structured storage system capable of storing and managing basic personal information and activity information, including but not limited to relational databases, NoSQL databases, key-value stores, or other persistent storage systems.

The term “generative AI model” refers to an artificial intelligence model configured to generate text, recommendations, or other output content in response to an input, such as a prompt sentence, and includes, for example, large language models and other machine learning models capable of generating human-readable advice or proposals.

The term “prompt sentence” refers to a text or structured instruction provided to the generative AI model, the content of which guides the generative AI model to generate a specific type of output, such as a proposal for a user action, a dietary recommendation, or an exercise recommendation.

The term “health condition” refers to a state of the user's physical and mental health as inferred from the basic personal information and activity information, including indicators such as weight status, lifestyle balance, sleep sufficiency, exercise sufficiency, and emotional well-being.

The term “emotion engine” refers to a software module, hardware module, or combination thereof configured to analyze emotional state information in order to recognize or classify the user's emotional condition, using, for example, rule-based processing, machine learning, or other signal processing techniques.

The term “advice corresponding to the recognized emotion” refers to guidance or recommendations generated or selected based on the user's recognized emotional state, such that the tone, content, or timing of the advice is adjusted to be appropriate, supportive, and motivating for the user's current emotional condition.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

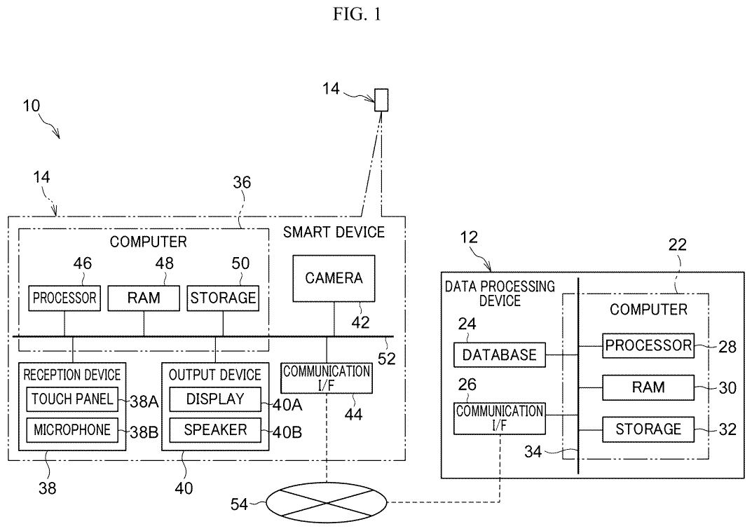

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

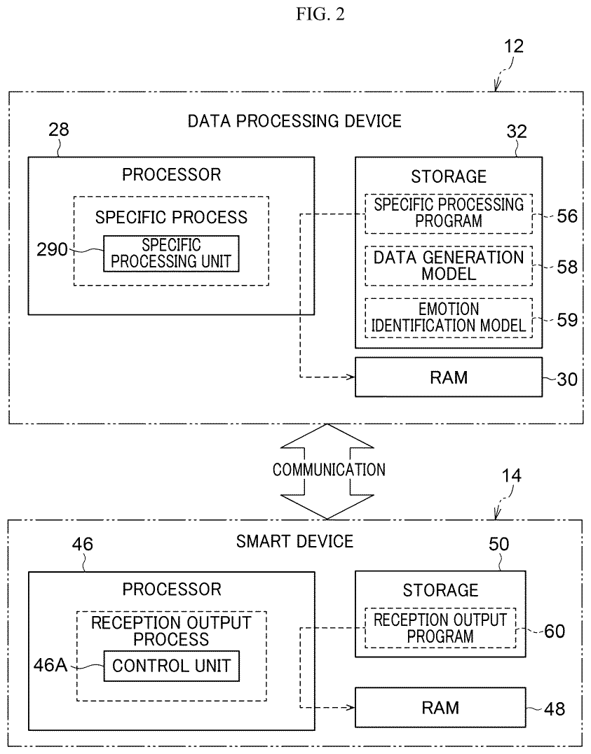

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional health support systems that simply collect user lifestyle logs and display pre-defined recommendations have several technical limitations from the standpoint of computer technology. First, such systems typically treat user attribute information (for example, age, sex, weight) and behavior information (for example, meals, sleep, physical activity, emotional state) as flat records and do not maintain structured, time-series representations with explicit update histories. As a result, server-side processing cannot efficiently perform temporal analysis or dynamically adapt subsequent processing steps, which limits the ability of the computing system to generate context-aware outputs and leads to inefficient use of storage and computation resources.

Second, existing systems generally pass raw or minimally processed data to a machine learning component or rule engine, without forming an optimized, structured natural-language prompt sentence that encodes both the user's state and explicit constraints on model behavior. This leads to non-deterministic and inconsistent outputs from generative AI models, wastes network and computation resources due to unnecessary or redundant prompts, and makes it difficult to systematically control the style, structure, and safety of generated content. In particular, there is no mechanism at the system level to dynamically rewrite prompt sentences in response to evolving user behavior logs and emotional states, which prevents the computing system from efficiently converging on personalized, stable advice patterns. Third, conventional emotion-aware systems do not tightly integrate emotion estimation with prompt-generation logic. Emotional state information, when used at all, is typically processed separately from the content generation pipeline and is not fed back into the generation of machine-readable inputs to a generative AI model. As a result, server processing cannot automatically adjust the tone, intensity, or structure of generated advice in accordance with real-time emotional tendencies of the user, thereby degrading user engagement and leading to suboptimal computational usage when generating advice that is repeatedly ignored or resisted. Fourth, known architectures often treat each advice generation as an isolated transaction, without maintaining an iterative optimization loop between user feedback (for example, whether advice was followed), updated behavior logs, and subsequent prompt sentences. This lack of closed-loop design at the server side prevents the computing system from refining internal representations and prompt content over time, thereby failing to exploit temporal patterns and feedback signals that could improve the quality and efficiency of generated outputs.

Accordingly, there is a need for a computer-implemented system that (i) structures and stores user attribute and behavior data together with update histories in a form suitable for time-series analysis, (ii) programmatically constructs and updates prompt sentences for a generative AI model based on computed indicators and constraints, (iii) integrates emotion estimation results into the prompt-generation pipeline to control the tone and content of generated advice, and (iv) operates the entire server-side process as an iterative optimization loop that adapts to user feedback and behavior changes. Such a system would improve the functioning of the server computer itself by enabling more efficient data handling, more controllable model interaction, and more targeted use of computational resources for generating health-related advice.

The specific processing by the specific processing unit 290 of the data processing device 12 in Example 1 is realized by the following means.

The present invention provides a server comprising a processor and a storage device, the processor being configured to acquire, via a communication interface, user attribute information and time-varying behavior information from an information processing terminal, to store the acquired information in the storage device as structured, time-stamped records with associated update histories, to execute analysis logic that computes indicator values including at least an average sleep time, an activity frequency, and an eating tendency from the stored behavior information, to construct, in accordance with a predefined template, a prompt sentence expressed in natural language that embeds the user attribute information, the indicator values, a target state of the user, and explicit constraint conditions and output format instructions for a generative AI model, to supply the constructed prompt sentence as input data to the generative AI model via a model interface, to receive from the generative AI model a response sentence including health-related advice information, to segment the response sentence into categorized advice elements with metadata and to store the categorized advice elements as history information in the storage device, to apply an emotion estimation mechanism to the behavior information and the response content so as to derive an emotional tendency of the user, and, based on the derived emotional tendency and on updated behavior information and feedback about implementation status of previous advice, to dynamically regenerate subsequent prompt sentences by adjusting at least instruction content and expression intensity, thereby iteratively optimizing the health-related advice information generated by the generative AI model. This enables the server to improve internal data management and computational workflows by maintaining a structured, time-series representation of user information, by generating controlled and context-rich prompt sentences that yield more consistent and relevant model outputs, by adaptively modulating advice tone and content based on emotion-aware analysis, and by operating a closed-loop, feedback-driven optimization process that enhances the efficiency and effectiveness of computer-implemented health advice generation.

The term “system” refers to a combination of at least one server, at least one information processing terminal, and associated communication paths and software components that cooperate to execute the processing defined in the claims.

The term “processor” refers to one or more hardware computation units, such as a central processing unit or a processing core, configured to execute program instructions to perform data acquisition, analysis, prompt generation, model interfacing, and response processing.

The term “storage device” refers to a hardware storage component, such as a memory device or a non-volatile storage unit, configured to store structured data, update histories, analysis results, prompt sentences, and generated advice.

The term “information storage region” refers to a logical storage area within the storage device in which user attribute information, behavior information, update histories, and advice histories are stored in an organized manner.

The term “information processing terminal” refers to an electronic data processing apparatus, such as a mobile communication device, a tablet device, or a personal computer, that is operated by a user to input information and to receive and display advice.

The term “communication path” refers to a logical or physical communication link, such as a wired or wireless network connection, that enables data exchange between the information processing terminal and the server.

The term “user” refers to a human individual who operates the information processing terminal and whose attribute information and behavior information are processed by the system.

The term “attribute information” refers to basic information describing inherent characteristics of the user, including at least age, sex, weight, and a target state, and possibly other static or slowly changing profile data.

The term “behavior information” refers to time-varying information describing daily activities and conditions of the user, including at least meal information, sleep information, physical activity information, and emotional state information.

The term “target state” refers to a desired future condition or goal of the user relating to health, body composition, or lifestyle, such as a target weight or a target activity level.

The term “structured data” refers to data arranged according to a predefined schema or format, including fields, data types, and relationships, enabling systematic storage, retrieval, and processing by the processor.

The term “update history” refers to information indicating temporal changes of stored data, including timestamps and versioning or sequence information that allow identification of when and how behavior information has been modified.

The term “time-series” refers to a representation of data ordered in time, such that each data item is associated with at least one time index, enabling temporal analysis by the processor.

The term “indicator information” refers to derived values computed from raw behavior information, including at least an average sleep time, an activity frequency, and an eating tendency, and optionally other summary statistics or scores.

The term “average sleep time” refers to a calculated value representing mean sleep duration over a specified time interval derived from the user's sleep-related behavior information.

The term “activity frequency” refers to a calculated measure indicating how often a physical activity or exercise event occurs within a specified time period.

The term “eating tendency” refers to an indicative characterization of the user's eating patterns, such as frequency or intensity of high-calorie intake, derived from meal-related behavior information.

The term “prompt sentence” refers to a sequence of natural-language text generated by the processor that encodes user attribute information, indicator information, target state, and explicit instructions or constraints for a generative AI model.

The term “natural language” refers to a human language, such as a spoken or written language used by people, in contrast to a programming language or machine code.

The term “constraint conditions” refers to explicit instructions embedded in the prompt sentence that restrict or guide the behavior of the generative AI model, including limitations on content, style, or scope of generated outputs.

The term “output format instructions” refers to directives included in the prompt sentence that specify how the generative AI model should structure its response, such as by categories, bullet points, sections, or fields.

The term “generative AI model” refers to a trained machine learning model, including at least a large language model, that performs natural language generation or transformation based on input text such as a prompt sentence.

The term “input data for the generative AI model” refers to data supplied to the generative AI model, including at least the prompt sentence and optionally additional parameters, which the model uses to generate a response.

The term “response sentence” refers to natural-language output generated by the generative AI model in response to the input data, containing at least health-related advice information for the user.

The term “health-related advice information” refers to information generated for the purpose of supporting improvement or maintenance of the user's health state, including proposals regarding meals, physical activity, sleep, and emotional management.

The term “category pieces” refers to segments of the response sentence that have been divided according to semantic categories, such as proposals relating to meals, proposals relating to physical activity, proposals relating to sleep, and proposals relating to emotional state.

The term “metadata” refers to auxiliary data associated with category pieces, such as category labels, timestamps, priority indicators, or other descriptors that facilitate storage, retrieval, and display.

The term “history information” refers to stored records of previously generated advice, including category pieces and associated metadata, allowing retrieval and analysis of past outputs.

The term “machine-readable data” refers to data encoded in a structured format, such as a serialized or markup representation, that can be parsed and processed by the information processing terminal without human interpretation.

The term “emotional state information” refers to behavior information relating to the user's mood or affective condition, such as stress level, motivation, or reported feelings.

The term “emotional processing mechanism” refers to a software or hardware module configured to estimate or infer an emotional tendency of the user based on emotional state information, response content, or other input signals.

The term “emotion estimation processing” refers to computational operations that analyze input data to infer an emotional tendency, such as classifying emotion categories or determining intensity levels.

The term “emotional tendency” refers to a characterization of a user's prevailing or recent emotional condition, such as being positive, neutral, or negative, or being motivated or demotivated.

The term “instruction content” refers to the substantive part of a prompt sentence that tells the generative AI model what type of information or advice to generate.

The term “expression intensity” refers to a degree or strength of language used in the prompt sentence, such as the level of emphasis, urgency, or softness in the wording.

The term “encouragement-oriented advice” refers to health-related advice information expressed in a motivational and supportive tone intended to encourage the user's actions.

The term “warning-oriented advice” refers to health-related advice information expressed in a cautionary or alerting tone intended to draw attention to risks or necessary changes.

The term “operation information” refers to information representing user interactions with the advice, such as confirmations, completions, or rejections, received from the information processing terminal.

The term “implementation status” refers to a state indicating whether and to what extent the user has followed or executed previously provided advice.

The term “iteratively optimize” refers to a process in which the system repeatedly generates advice, obtains new behavior information and feedback, and updates subsequent prompt sentences to progressively improve the relevance and effectiveness of generated advice.

The term “model interface” refers to a software interface, such as an application programming interface, through which the processor communicates with the generative AI model.

The term “dietary management advice” refers to a subset of health-related advice information focused on regulating food intake, energy intake, and food selection.

The term “sleep time shorter than a predetermined threshold” refers to a sleep duration measured from behavior information that is less than a reference value specified by system settings or rules.

The term “activity amount” refers to a measure of physical activity, such as total duration, distance, or energy expenditure within a specified time interval.

The term “activity plan” refers to a structured set of proposals for physical activity, including at least an activity amount, an activity type, and an implementation schedule.

The term “implementation schedule” refers to a temporal arrangement of proposed actions, specifying at least time slots, days, or frequencies for performing activities.

In one embodiment, a server, a terminal, and a user cooperate to implement the invention.

The server includes at least one processor, a main memory, a non-volatile storage device, and a network interface. For example, the server uses a general-purpose computing platform such as an x86 or ARM server running a server operating system, such as a UNIX-like operating system. The server executes application programs implemented using server-side software frameworks such as a web framework and a data access library. The server also accesses a database system such as a relational database management system, and a generative AI model execution environment such as a model-serving framework operating on one or more accelerators such as graphics processing units.

The terminal includes at least one processor, a memory, a display device, an input device, and a communication interface. For example, the terminal uses a smartphone platform, a tablet platform, or a personal computer platform that executes a client application or a web browser. The terminal executes a client application implemented with a native framework or a browser-based application implemented with markup language and a scripting language. The terminal acquires user input, constructs structured messages, and transmits the messages to the server via a network such as a cellular network, a wireless local area network, or a wired local area network.

The user operates the terminal to input attribute information and behavior information and to view health-related advice information presented by the terminal. The user does not directly interact with the internal data representations or model interfaces of the server. The server stores user attribute information and behavior information in the database in a structured, time-series format. In one embodiment, the server uses a relational schema including at least a user table, a profile table, an activity log table, an emotion log table, and an advice history table. The server assigns a unique user identifier to each user and uses foreign key relationships to associate profile records, activity records, emotion records, and advice records with the user identifier.

The server represents behavior information as records that contain a timestamp, a behavior type identifier (for example, meal, sleep, physical activity, emotional state), and normalized values. For example, meal information is normalized to caloric estimates and food type categories, sleep information is normalized to sleep duration and sleep start and end times, physical activity information is normalized to activity type, duration, and estimated energy expenditure, and emotional state information is normalized to discrete emotion labels and intensity scores. The server maintains an update history by storing multiple records over time and by annotating each record with creation and modification timestamps. The server thus maintains a time-ordered sequence of behavior records for each user.

The server aggregates behavior information to compute indicator information. The server uses deterministic algorithms executed on the processor to compute an average sleep time over a specified window (for example, a rolling seven-day window), to compute an activity frequency as a count of physical activity records within a time window, and to compute an eating tendency score based on the frequency and estimated energy content of high-calorie meals. The server can compute additional indicators such as sleep variability, ratio of active days to inactive days, or a balance between macronutrient categories. These indicators are stored in the database as numerical values in a separate indicator table linked to the user identifier and a reference time period.

The server constructs a prompt sentence to be supplied as input data to a generative AI model. The server uses a template-based generation mechanism in which a predefined natural-language template is populated with the user's attribute information, the indicator information, and a target state. The server also embeds explicit constraint conditions and output format instructions in the prompt sentence. In one embodiment, the server constructs a prompt sentence such as:

“Act as a professional health and wellness coach.

User profile: 30-year-old male, current weight 80 kg, target: lose 5 kg.

Lifestyle: recent meals are high-calorie, exercise is once per week, sleep is 6 hours per night on average.

Within the scope of general wellness (diet, exercise, sleep), provide concrete and safe advice.

Please output:
1) A weekly exercise plan,
2) Key dietary changes,
3) Sleep improvement recommendations, in clear bullet points.”

In another embodiment, the server constructs a more detailed prompt sentence such as:

“Act as a certified health and wellness coach.

User profile: 30-year-old male, current weight 80 kg, target: lose 5 kg within the next 3 months.

### Lifestyle Information:

Diet: frequent high-calorie dinners with sugary drinks.
Exercise: light jogging once per week for 20 minutes.
Sleep: averages 6 hours per night and uses a smartphone in bed.

Within the scope of general wellness (no medical diagnosis, no medication advice), provide:
1) A realistic 4-week exercise plan to gradually increase activity,
2) Specific and practical dietary adjustments to reduce calorie intake while keeping meals satisfying,
3) Concrete steps to improve sleep quality and increase sleep duration toward 7 hours.

Format the answer in clear bullet points for each of the three categories: Exercise Plan, Diet Plan, and Sleep Tips.”

The server generates such prompt sentences using a string concatenation and formatting module. The module selects template segments based on conditions, such as presence of sleep deprivation or low activity frequency, and replaces placeholder tokens with actual values retrieved from the database. By centralizing prompt construction and explicitly encoding structure and constraints, the server reduces variability of inputs to the generative AI model and therefore improves the consistency and predictability of model outputs. This provides a technical improvement over ad hoc prompt submission, because the server can reuse prompt structures across users while customizing content, leading to reduced network payload size and improved processing efficiency at the model interface.

The server interfaces with a generative AI model implemented as a neural network. In one embodiment, the generative AI model uses a transformer-based architecture that includes multiple self-attention layers, feedforward layers, and embedding layers. The model is trained offline using a large corpus of text data via a supervised or self-supervised learning method. During training, the model minimizes a loss function such as cross-entropy between predicted token distributions and ground truth tokens. The training process uses gradient-based optimization methods such as stochastic gradient descent or an adaptive optimizer. The model updates weight parameters for attention matrices, layer normalization gains, and feedforward layer weights using backpropagation. The training pipeline can also use data augmentation techniques such as random masking, token shuffling within limits, or noise injection to improve generalization.

The server uses this trained generative AI model during inference. The server tokenizes the prompt sentence into a sequence of token identifiers using a tokenizer consistent with the model's vocabulary. The server then transmits the token sequence or corresponding text through a model-serving API. The model executes attention computations and matrix multiplications on parallel hardware such as a GPU to compute probability distributions over next tokens at each decoding step. The model then generates a response sentence in a streaming or batch fashion.

The server does not treat the generative AI model as a black box. The server constrains model behavior by precisely controlling the prompt content, model parameters such as maximum token length, temperature, and top-k or nucleus sampling thresholds. For example, the server can reduce randomness to obtain more deterministic responses when stable advice is needed, thereby reducing variance in advice content for a given user state. This results in a technical effect of reduced need for repeated model calls and post-filtering, which reduces computational consumption and network traffic.

The server performs emotion estimation as a separate but integrated module. The server derives emotional state information from behavior logs and from textual feedback or diary entries that the user enters on the terminal. The server uses a classification model, which may be another neural network such as a smaller transformer or a recurrent network, trained to map text to emotion categories and intensities. The server calculates features such as word frequency of affective terms, sentence length, and punctuation patterns, and the classification model produces an emotion label such as “stressed,” “motivated,” or “discouraged” with an associated confidence score. The server then maps this emotional tendency to a control parameter for prompt construction, such as a “tone” parameter.

The server modifies the prompt sentence based on the emotional tendency. For example, if the emotion estimation mechanism indicates a discouraged state, the server emphasizes encouragement-oriented wording in the prompt sentence, such as: “Provide gentle, encouraging guidance, focusing on small, achievable steps and positive reinforcement.” If the mechanism indicates a complacent state with poor adherence, the server emphasizes warning-oriented wording, such as: “Clearly explain the risks of continuing current habits and provide strong, but still supportive, warnings about the consequences of inaction.” By adjusting instruction content and expression intensity in the prompt sentence, the server induces the generative AI model to produce advice with different tones. This control is implemented by deterministic logic at the server, not by human intervention, thereby constituting a technical improvement in how the server uses model outputs in a closed loop.

The server segments the response sentence into category pieces. The server parses the response text using a parser that identifies headings, bullet markers, or specific keywords. For example, the server extracts lines under “Exercise Plan” as exercise-related advice, lines under “Diet Plan” as diet-related advice, and lines under “Sleep Tips” as sleep-related advice. The server further adds metadata such as category label, priority level, and corresponding indicator IDs. These category pieces are stored in an advice history table, where each piece is associated with a user identifier, a timestamp, and a reference to the prompt parameters (such as tone and constraint settings). This structured storage allows the server to efficiently retrieve and compare advice over time, to avoid redundant advice generation, and to tailor new advice by referring to previously delivered content. The technical effect is improved data management and reduced computation because the server reuses relevant advice segments when appropriate.

The server also collects feedback from the terminal about implementation status. The user marks items as completed or skipped, and the terminal sends this information as operation information. The server encodes implementation status as numerical adherence scores and stores them in the database. The server then uses adherence statistics as additional features for subsequent indicator computation. For example, the server lowers the effective activity frequency if the user often marks exercise items as skipped even when they were recommended. The server uses these adherence-adjusted indicators in future prompt sentences, which allows the generative AI model to generate advice that accounts for behavioral patterns, such as recommending shorter or less frequent activities when adherence is low. This adaptive process is not a mere automation of human coaching; it uses machine-parsable history and control of model parameters to algorithmically adjust advice granularity and tone. This provides a technical effect of reducing unnecessary communication between the server and the model by avoiding advice patterns that have proven ineffective. The server reduces communication load by compressing the content of prompt sentences to the minimum necessary information while preserving key indicators and constraints. For example, instead of transmitting all past activity logs, the server transmits only aggregated indicator values and a concise narrative summary. This reduces prompt length, which reduces the number of tokens processed by the generative AI model, thereby lowering inference time and computational resource consumption. The server can also cache model responses and reuse them for similar indicator profiles, further reducing calls to the model.

In an alternative embodiment, the server executes the generative AI model locally on the same hardware platform instead of via a remote model-serving API. In this embodiment, the server loads model parameters into local memory and performs all inference computations on local accelerators. This configuration reduces network latency and offers increased control over processing. The data structures and prompt generation mechanisms remain the same, but the model interface is implemented as a local function call rather than a remote procedure call. In another embodiment, the server employs a smaller, domain-specific model for certain subtasks, such as generating brief summaries of advice or translating model output into a particular language. The server chains multiple models, where the main generative AI model generates raw advice and a secondary model or rule-based module refines formatting or simplifies language. This modular structure allows the server to allocate heavy computation only to core content generation, while using lighter-weight processing for formatting, thus improving overall computational efficiency.

In another variation, the server supports multiple target states, such as weight reduction, muscle gain, sleep quality improvement, or stress reduction. The server modifies the indicator computation and prompt templates accordingly. For example, for stress reduction, the server emphasizes emotion logs and sleep variability; for muscle gain, the server emphasizes protein intake and resistance training frequency. This flexible configuration demonstrates that the core technical contribution—the structured data storage, indicator computation, controlled prompt construction, and closed-loop adaptation—is not limited to a single health goal but remains applicable to a range of wellness objectives.

By implementing these mechanisms, the server improves the functioning of the computer system as a whole. The server transforms raw, heterogeneous user logs into structured, time-series data; computes indicators that reduce dimensionality and capture essential trends; constructs systematically controlled prompt sentences; and uses emotion-aware modulation and adherence-based feedback to guide a generative AI model. The resulting system reduces redundant processing, increases prediction and recommendation stability, and minimizes communication overhead between the server and the model execution environment. These concrete improvements to data management, computational efficiency, and model interaction demonstrate that the invention is rooted in computer technology and is not merely a generic automation of human coaching.

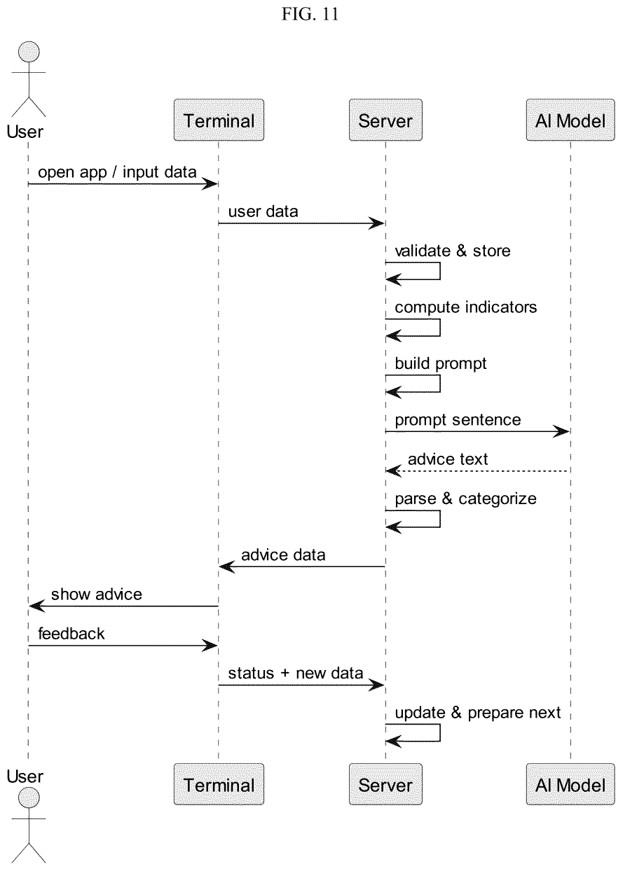

The following describes the processing flow using FIG. 11.

### Step 1:

User operates the terminal to start a health-coaching session.

User launches a client application or a web browser on the terminal and opens a screen for health management.

Input: User intention to use the system (for example, tapping an app icon).

Output: Displayed UI for login or profile input.

Terminal loads the initial UI resources from local storage or from the server and prepares input fields for authentication and health-related data entry.

### Step 2:

User enters attribute information and behavior information on the terminal.

User inputs age, sex, weight, and target state, and also inputs recent meal, sleep, physical activity, and emotional state information using form controls on the display.

Input: Raw user keystrokes, touch events, and selections.

Output: Structured in-memory data objects on the terminal that represent attribute information and behavior information.

Terminal converts the input events into typed values (for example, integers for age, floating-point values for weight, enumerations for sex and emotion) and validates basic format locally (for example, checking that age is within a plausible range).

### Step 3:

Terminal transmits structured user information to the server.

Terminal packages the attribute information and behavior information into a structured message and attaches identification information or an authentication token, then sends the message to the server over a network connection using a defined application protocol.

Input: In-memory structured user data and authentication token on the terminal.

Output: A network request containing serialized user data delivered to the server.

Terminal serializes the data (for example, into a text-based structure), opens a secure channel, and sends the serialized data using a request message.

### Step 4:

Server receives and parses the transmitted user information.

Server accepts the incoming request through a network interface, decodes the serialized data, and reconstructs attribute information and behavior information as server-side data structures.

Input: Serialized user data contained in the network request.

Output: Server-side structured objects representing attribute information and behavior information.

Server verifies authentication, performs schema validation, converts units if necessary (for example, pounds to kilograms), and normalizes categorical values (for example, mapping free-text sex entries to allowed category codes).

### Step 5:

Server stores time-series behavior data and attribute data in the storage device.

Server maps the structured objects to database records and writes them into appropriate tables with timestamps.

Input: Validated attribute information and behavior information in memory.

Output: Inserted or updated records in the storage device, including a new entry in an activity log or emotion log.

Server generates SQL or equivalent data operations, writes the records, and records creation and update times, thereby extending the update history associated with the user.

### Step 6:

Server computes indicator information from stored behavior data.

Server reads recent behavior records for a specified period from the database and applies aggregation functions.

Input: Multiple behavior records retrieved from the storage device, each containing at least a timestamp, type, and normalized values.

Output: Indicator values such as average sleep time, activity frequency, and eating tendency scores.

Server sums sleep durations and divides by the number of days to compute average sleep time, counts exercise events per period to compute activity frequency, and applies a scoring function to meal records (for example, weighting high-calorie events) to derive an eating tendency score.

### Step 7:

Server constructs a prompt sentence for the generative AI model.

Server assembles a natural-language text that encodes attribute information, indicator information, and the user's target state, along with constraint conditions and output format instructions.

Input: Attribute information, computed indicator values, target state, and pre-defined template segments stored in memory or configuration.

Output: A complete prompt sentence expressed as a text string.

Server fills template placeholders with specific values (for example, “30-year-old male, current weight 80 kg, target: lose 5 kg”) and appends control phrases such as “Within the scope of general wellness, provide concrete and safe advice in bullet points,” thus producing a structured, machine-constructed prompt sentence.

### Step 8:

Server adjusts prompt tone and content based on emotional tendency.

Server retrieves recent emotional state records and applies an emotion estimation mechanism to infer an emotional tendency, then modifies parts of the prompt sentence accordingly.

Input: Emotion-related behavior information and a baseline prompt sentence.

Output: A tone-adjusted prompt sentence that includes instructions for encouragement-oriented or warning-oriented advice.

Server classifies emotion logs into states (for example, “discouraged” or “complacent”) and conditionally inserts instruction phrases such as “Use gentle and encouraging wording” or “Emphasize risks and necessary changes,” thereby altering the wording and emphasis in the prompt sentence before sending it to the generative AI model.

### Step 9:

Server sends the prompt sentence to the generative AI model and receives a response.

Server transmits the prompt sentence to a generative AI model execution environment through a model interface and obtains generated text.

Input: Final prompt sentence and optional model control parameters (for example, maximum length, temperature).

Output: A response sentence containing health-related advice text.

Server tokenizes the prompt sentence if required by the model interface, sends the tokens or text, and waits for the model to perform internal neural computations; the server then reconstructs the returned tokens into a response sentence string.

### Step 10:

Server parses and categorizes the response sentence.

Server analyzes the response text to divide it into category pieces for meals, physical activity, sleep, and emotional support.

Input: Response sentence text returned by the generative AI model.

Output: Multiple categorized advice elements each tagged with metadata.

Server scans for headings or key phrases (for example, “Exercise Plan:”, “Diet Plan:”, “Sleep Tips:”), splits the text at these boundaries, and assigns category labels, timestamps, and priority levels to each segment, thus creating structured advice objects.

### Step 11:

Server stores advice history and sends advice data to the terminal.

Server writes the categorized advice elements into the advice history area of the storage device and then composes a reply message to the terminal.

Input: Categorized advice elements with metadata.

Output: Persisted advice history records and a network response carrying structured advice data.

Server performs database insert operations to store each advice element along with user identifier and generation time, converts the advice elements into a machine-readable response format, and transmits the response through the network interface to the terminal.

### Step 12:

Terminal displays categorized advice to the user.

Terminal receives the structured advice data, creates visual components, and presents them on the display.

Input: Structured advice data received from the server.

Output: Rendered advice lists, sections, or cards on the terminal screen.

Terminal groups exercise-related, diet-related, sleep-related, and emotion-related items, shows them with labels and possibly checkboxes or buttons, and updates internal state so that user interactions can be captured as operation information.

### Step 13:

User interacts with advice and records implementation status.

User reads each advice item and performs actions such as marking items as completed, postponing them, or indicating that they were not followed.

Input: Visual advice items and control elements on the terminal screen.

Output: User interaction events that represent implementation status and feedback.

Terminal converts taps and selections into structured status records (for example, “exercise item 1: completed”, “diet item 2: skipped”) and prepares them for transmission.

### Step 14:

Terminal sends implementation status and updated behavior information to the server.

Terminal bundles the user's feedback on advice and any newly entered behavior information into a structured message and transmits it.

Input: Local status records and new behavior entries stored on the terminal.

Output: A network request containing updated behavior information and operation information sent to the server.

Terminal serializes this data with time stamps and identifiers, then sends it over the existing secure communication channel.

### Step 15:

Server incorporates feedback, updates records, and prepares for iterative optimization.

Server receives the new operation information and behavior updates, stores them as new records, and recalculates indicators to be used in subsequent prompt sentences.

Input: Updated behavior information and implementation status data received from the terminal.

Output: Updated database records and revised indicator values ready for use in the next advice generation cycle.

Server writes adherence metrics (for example, completion ratios for exercise items) into the storage device, modifies algorithms for computing activity frequency and effective adherence, and updates internal state so that the next prompt sentence will reflect the user's actual behavior and response to previous advice, thereby enabling an iterative refinement process in subsequent executions of Steps 6 through 11.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional health support systems that utilize computers to provide dietary and exercise advice typically rely on fixed rule sets, static templates, or simple numerical thresholds. Such systems often treat user attribute data, lifestyle activity data, and emotional state data as independent inputs and do not integrate them into a unified machine-readable representation that can fully leverage modern generative AI models. As a result, the systems generate generic or fragmented recommendations, fail to adapt to dynamic changes in user behavior and emotion, and cannot efficiently produce machine-usable outputs that are directly actionable in downstream services such as order management for external article providing services.

Furthermore, existing architectures frequently separate data collection, analysis, and content generation into loosely coupled modules without an optimized data flow tailored to generative AI models. Input information from terminals is often stored as heterogeneous, ad hoc records, requiring significant ad hoc preprocessing each time a model is invoked. This leads to increased computational overhead, latency, and inconsistency in model inputs, thereby degrading both system responsiveness and the quality of generated advice. In addition, emotional state data, when used at all, is commonly handled only at the user interface layer and is not embedded as a structured constraint or condition in the prompts supplied to generative AI models. Consequently, output text from such models does not reliably reflect the user's emotional context.

Moreover, known systems do not provide an integrated mechanism for automatically mapping generated meal plans, which are typically expressed in free-form natural language, to structured item information of external article providing services. This lack of linkage requires manual interpretation and selection by users or service operators, introduces errors and inefficiencies, and prevents seamless end-to-end execution from health analysis to actual provisioning of meals. Also, user selections and feedback are often stored only as isolated preference flags or ratings and are not fed back into the prompt generation logic in a structured, model-aware manner. This results in limited personalization and failure to improve advice generation over time.

In summary, there is a need for an improved computer-implemented health support system and server-side processing architecture that: (i) systematically converts heterogeneous user attribute, lifestyle activity, and emotional state information into structured data suitable for generative AI processing; (ii) automatically constructs and updates prompt sentences that integrate analytical indices and emotional context; (iii) generates advice information in a form that can be directly mapped to item information of external article providing services; and (iv) uses user selection history and feedback to iteratively refine subsequent prompt generation and advice generation. Such improvements would enhance the technical performance of the underlying computing system, including data handling efficiency, model invocation efficiency, and the consistency and utility of generated outputs.

The specific processing by the specific processing unit 290 of the data processing device 12 in Application Example 1 is realized by the following means.

The present invention provides a server comprising a processor and a storage medium, the processor being configured to receive, from a terminal, basic attribute information including a target health state of a user, age, sex, and physical characteristics, and lifestyle activity information including meals, sleep, exercise, and emotional state, and to store the received information as structured data in the storage medium; to perform statistical processing and feature generation processing on the stored basic attribute information and lifestyle activity information to calculate, for the user, at least a nutrition index and an exercise index; to generate a prompt sentence written in natural language, the prompt sentence including the calculated nutrition index and exercise index together with at least a portion of the basic attribute information and the lifestyle activity information, and to input the prompt sentence to a generative AI model so as to cause the generative AI model to generate advice information including a meal plan and an exercise plan according to a health state of the user; to analyze the emotional state included in the lifestyle activity information by using an emotion analysis algorithm and to reflect an analysis result of the emotional state in the prompt sentence so as to cause the generative AI model to generate advice information including expressions and contents corresponding to the emotional state of the user; to analyze the advice information acquired from the generative AI model to extract a meal plan including nutrient composition information, and to associate elements of the meal plan with item information of an external article providing service so as to generate selectable meal options for ordering; and to transmit the selectable meal options and the exercise plan to the terminal, to receive from the terminal selection operations and feedback information from the user, to store a selection history and the feedback information in the storage medium, and to reflect at least part of the selection history and the feedback information in a subsequent generation of the prompt sentence and in subsequent generation of the advice information.

This enables a computer system to more efficiently transform heterogeneous health-related and emotional data into structured prompts for generative AI processing, to reduce computational overhead and latency in advice generation, to automatically produce machine-usable outputs that are directly linked to external article providing services, and to iteratively improve personalization and relevance of generated recommendations based on user interactions, thereby improving the overall technical performance of the health support system.

The term “processor” refers to one or more hardware processing units, such as a central processing unit or graphics processing unit, configured to execute program instructions to perform data processing operations described in the system.

The term “terminal” refers to an information processing device operated by a user, such as a portable communication device, a personal computer, or a tablet device, capable of inputting data and displaying information via a communication network.

The term “user” refers to a human individual who provides personal information and lifestyle activity information to the system and receives advice information and selectable options from the system.

The term “basic attribute information” refers to user-related information that includes at least a target health state of the user, an age of the user, a sex of the user, and physical characteristics of the user, such as body weight, height, or body composition.

The term “lifestyle activity information” refers to time-varying information representing daily activities of the user, including at least information about meals, sleep, exercise, and emotional state.

The term “target health state” refers to a desired future condition of the user with respect to health, including at least goals such as body weight, body composition, fitness level, or wellness status.

The term “physical characteristics” refers to measurable attributes of the user's body, including at least body weight, height, body mass index, body fat percentage, or similar physiological indicators.

The term “emotional state” refers to a psychological condition of the user at a given time, including at least emotions such as happiness, sadness, anxiety, stress, or similar affective states.

The term “storage medium” refers to a non-transitory computer-readable medium, such as a magnetic storage device, an optical storage device, a semiconductor memory, or a distributed storage system, configured to store structured data and program instructions.

The term “structured data” refers to information stored in a machine-readable format with a predefined schema or data model, such as records in a relational database or objects in a key-value or document-oriented database.

The term “statistical processing” refers to numerical operations performed on stored data, including at least aggregation, averaging, normalization, or other statistical computations used to derive quantitative measures from basic attribute information and lifestyle activity information.

The term “feature generation processing” refers to processing that derives feature values from raw data, including at least calculation of indices, encoding of categorical variables, normalization of numerical values, and transformation of time-series data into feature vectors suitable for input to machine learning models.

The term “nutrition index” refers to a quantitative indicator derived from the basic attribute information and the lifestyle activity information that represents at least recommended nutrient intake or caloric requirements for the user.

The term “exercise index” refers to a quantitative indicator derived from the basic attribute information and the lifestyle activity information that represents at least recommended exercise amount, intensity, or frequency for the user.

The term “prompt sentence” refers to a sequence of natural language text that encodes user-related information, analytical indices, and instructions, and that is provided as input to a generative AI model to control generation of output content.

The term “generative AI model” refers to an artificial intelligence model trained to generate output data, including at least natural language text, in response to input data such as a prompt sentence, by sampling or calculating sequences of tokens based on model parameters.

The term “advice information” refers to information generated by the generative AI model based on the prompt sentence, including at least a meal plan, an exercise plan, and explanatory or motivational text tailored to the user.

The term “meal plan” refers to a plan defining one or more meals for one or more time periods, including at least dish names, quantities, or nutrient composition information suitable for consumption by the user.

The term “exercise plan” refers to a plan defining one or more physical activities for one or more time periods, including at least exercise types, durations, intensities, or frequencies recommended for the user.

The term “emotion analysis algorithm” refers to a software-implemented procedure or model configured to estimate an emotional state of the user from input data, such as self-reported text, questionnaire results, or other signals, and to output an analysis result representing the emotional state.

The term “analysis result of the emotional state” refers to data output by the emotion analysis algorithm that represents a classification, score, or distribution over possible emotional states of the user.

The term “nutrient composition information” refers to information indicating at least caloric value and macronutrient or micronutrient content of a meal or dish, such as amounts of proteins, fats, carbohydrates, vitamins, or minerals.

The term “external article providing service” refers to a service system operated by an external entity that manages provision of physical articles, including at least food items or meal kits, and that can receive order information via a communication interface.

The term “item information” refers to structured data managed by the external article providing service representing available articles, including at least identifiers, names, descriptions, prices, and nutritional attributes of articles.

The term “selectable meal options” refers to one or more candidate meals or meal combinations generated by the processor by associating elements of a meal plan with item information of an external article providing service, the candidate meals being displayable on the terminal for selection by the user.

The term “selection operations” refers to user interactions performed via the terminal to choose or modify one or more of the selectable meal options or exercise recommendations, including at least confirmation, rejection, or substitution operations.

The term “feedback information” refers to information provided by the user after receiving or using recommended meals or exercises, including at least ratings, evaluations, or comments representing satisfaction level or preferences.

The term “selection history” refers to accumulated records of past selection operations performed by the user with respect to selectable meal options or exercise recommendations.

The term “exercise load index” refers to a numerical indicator computed from lifestyle activity information including exercise type, exercise time, and exercise frequency, representing at least an overall physical load or training volume for the user.

In one embodiment, a server executes a computer program on one or more processors to implement a health support system that uses a generative AI model. The server operates in conjunction with one or more terminals operated by users. The terminal includes, for example, a smartphone, a tablet computer, or a personal computer, and executes an application or a web browser to provide a user interface. The server includes a non-transitory storage medium such as a database system, and executes application logic using an operating system such as a general-purpose server operating system. In some embodiments, the server executes machine learning components using a machine learning framework such as a tensor-based numerical computation framework or a dynamic computation graph framework, and executes a natural language processing component using a sequence modeling library. The terminal presents input screens for basic attribute information and lifestyle activity information. The user operates the terminal to input age, sex, body weight, height, target health state (for example, “lose 5 kg in 3 months” or “maintain current weight while increasing muscle mass”), dietary preferences, and allergies. The terminal also displays input elements for lifestyle activity information, including daily meals, sleep duration, and exercise type, duration, and frequency, and optionally a self-reported emotional state. The terminal locally validates each input, for example by checking that age and weight are numeric and within reasonable ranges, and that required fields are not empty. The terminal then encodes the validated information into a structured representation, for example a set of key-value pairs or an object structure, and transmits the structured data to the server over a network using a secure communication protocol.

The server receives the structured data and stores it as structured data in the storage medium. The server uses a defined schema, for example tables or collections for user profile, daily activity, and emotional state, each record including a user identifier, a timestamp, and typed fields. The server normalizes numeric values, for example converting body weight to a standard unit and converting times to minutes and to a common time zone. The server encodes categorical variables, for example mapping sex to integer codes, mapping exercise type to enumerated values, and mapping emotional states to discrete labels or continuous scores. By storing the data in such a structured and normalized form, the server reduces repeated preprocessing for each model invocation and improves cache utilization and retrieval efficiency.

The server performs statistical processing on the stored data. The server calculates, for each user, averaged and aggregated values such as average daily energy intake computed from recorded meals, average sleep duration over recent days, and total weekly exercise time derived from exercise records. The server also calculates dispersion measures such as variance or standard deviation of calorie intake and exercise duration, which are used as stability indicators. The server stores these derived statistics in dedicated fields in the storage medium, thereby avoiding recalculation for each subsequent request and reducing computational load.

The server performs feature generation processing to construct feature vectors suitable for machine learning. The server concatenates normalized basic attribute information, lifestyle activity information, and derived statistics into a fixed-length feature vector for each user. The feature vector may include, for example, age, normalized body mass index, encoded sex, a target weight difference, average daily calorie intake, average sleep hours, exercise minutes per week, exercise intensity codes, and one or more emotional state scores. The server further calculates a nutrition index, such as a recommended daily energy target and macronutrient distribution, using a nutrition estimation model implemented in a machine learning framework. The nutrition estimation model may be, for instance, a feedforward neural network with several fully connected layers and activation functions such as rectified linear units, trained on a dataset of user profiles and nutrition outcomes. The server also calculates an exercise index, representing recommended exercise amount and intensity, from the feature vector using a separate model or a parameterized function.

The server uses an emotion analysis algorithm to estimate a detailed emotional state of the user. In one embodiment, the terminal sends short free-text comments describing how the user feels. The server tokenizes the text, converts tokens to embeddings using a pre-trained word or sentence embedding model, and inputs the embeddings into a classification model, such as a recurrent neural network, a convolutional neural network, or a transformer-based encoder. The model outputs probabilities for emotional categories such as “stressed”, “motivated”, “tired”, or “anxious”. The server converts these probabilities into an emotional state representation, such as a label with a confidence score. This analysis result becomes part of the feature vector and is also explicitly encoded in a prompt sentence.

The server generates a prompt sentence for a generative AI model. The server constructs the prompt sentence in natural language, embedding the calculated nutrition index, the exercise index, key profile attributes, summarized lifestyle data, and emotion analysis results, together with explicit instructions regarding desired output structure and constraints. For example, the server may generate a prompt sentence such as:

“The user is a 30-year-old female. Current weight is 70 kg, height is 165 cm. The target health state is to lose 5 kg in 3 months while maintaining muscle mass. The average daily energy intake over the last 7 days is approximately 2200 kcal. The average sleep duration is 7 hours per night. The user performs light walking about 6000 steps per day. The analyzed emotional state is ‘slightly stressed’ with a tendency to snack late at night. Based on these conditions, generate a 7-day meal plan with three meals and one snack per day. Each day should have a total energy intake between 1500 and 1700 kcal, with a high-protein, moderate-carbohydrate, low-fat nutrient balance. Express the meals using realistic dishes that can be prepared by common food providers. Also include a brief explanation for each day describing how the meals support gradual weight loss and stress control.”

In another embodiment, the server constructs a prompt sentence focused on exercise and nutrition:

“User profile: age 45, male, weight 85 kg, height 175 cm. Target health state: reduce weight by 3 kg in 2 months and improve blood sugar control. Average sleep duration is 6 hours per night. Average exercise activity is light exercise 2 times per week. The emotion analysis indicates ‘low motivation’ and ‘mild fatigue’. Generate a 3-day plan that combines meals and exercise. For each day, provide breakfast, lunch, dinner, and one snack, with a total daily energy intake between 1800 and 2000 kcal and with low glycemic impact. Also propose two exercise sessions per day with type, duration, and intensity that are safe for a beginner. Explain in plain language how the combination of meals and exercise contributes to weight reduction and blood sugar control while taking low motivation and fatigue into account.” The server sends the prompt sentence to a generative AI model. In one embodiment, the generative AI model is a large language model implemented as a transformer-based neural network, with multiple self-attention layers, trained on large-scale text data and fine-tuned on health and nutrition-related content. The server communicates with the generative AI model through an application programming interface by transmitting the prompt sentence and configuration parameters such as maximum output length and temperature. The generative AI model performs token-by-token generation using its internal attention mechanisms and learned parameters, conditioned on the prompt sentence. Because the prompt sentence is systematically structured with explicit indices, constraints, and emotional context, the generative AI model produces output that is more consistent with numerical requirements and user-specific constraints than free-form input.

The server receives the generated text as advice information. The server parses the output using a deterministic parser or pattern-based parser that searches for sections indicating days, meals, nutrient values, and exercise instructions. In some embodiments, the server requires the generative AI model to follow a semi-structured format (for example, numbered days and labeled meals) as specified in the prompt sentence, which simplifies parsing. The server extracts, for each meal, dish names, approximate calories, and macronutrient composition, and for each exercise, type, duration, and intensity. The server verifies whether the summed daily calories and exercise loads fall within allowed ranges inferred from the nutrition index and exercise index. If the output violates critical constraints, the server can regenerate a refined prompt sentence that explicitly states the violation and instructs the generative AI model to correct it, thereby establishing a feedback loop that improves reliability. The server maps the extracted meal plan to item information of an external article providing service. The server maintains or accesses a catalog of available items, each item having an identifier, description, portion size, price, and optionally nutrient composition. The server converts dish names from the generated meal plan into vector representations using a semantic embedding model, and converts catalog item names and descriptions into similar vector representations. The server calculates similarities between the dish vectors and catalog item vectors using a distance metric such as cosine similarity, and selects, for each generated dish, one or more candidate catalog items whose similarity score exceeds a threshold. The server then constructs selectable meal options by linking the generated dish description with specific catalog item identifiers and associated metadata. This mapping process is more than simple keyword matching; it uses continuous vector spaces and trained embedding models to find semantically similar items, thereby improving matching accuracy and reducing manual intervention.

The terminal receives the selectable meal options and the exercise plan from the server. The terminal displays, for each day, the recommended meals and their mapped items, together with exercise suggestions. The user can inspect the options and select preferred meals for ordering. The terminal transmits the user's selection operations and optional feedback, such as ratings and comments, to the server. The server stores the selection history and feedback in the storage medium and aggregates them over time to derive user-specific preference features. The server incorporates these preference features into future feature vectors and prompt sentences. For example, if the user repeatedly rejects spicy dishes and provides low ratings for them, the server adds an explicit constraint in subsequent prompt sentences that the meals should be mild and not spicy. This mechanism allows the system to refine future guidance in a structured, model-aware manner rather than by static rules.

The server, by orchestrating these components, improves computer technology in several ways. By transforming heterogeneous raw input (numerical attributes, categorical variables, time-series data, free-text emotions) into well-defined feature vectors and structured prompt sentences, the server reduces variability in model inputs and lowers the error rate and latency associated with ad hoc preprocessing. The use of precomputed indices and cached statistics reduces repeated database scans and redundant calculations. The explicit encoding of constraints and emotional context in the prompt sentence allows the generative AI model to operate under tighter control, reducing the need for multiple regeneration cycles and decreasing communication overhead. The embedding-based mapping of generated meal descriptions to catalog items enables automatic, scalable linking between unstructured AI output and structured item databases, which is not feasible with traditional rule-based systems at similar scale and dynamicity.

The server uses specific learning methods for the internal models. During training of the nutrition index model and the exercise index model, the server reads historical records of users and corresponding outcomes from the storage medium. The server divides the data into mini-batches, computes predictions from the current model parameters, and evaluates a loss function, such as a mean squared error for regression of calorie targets, or a cross-entropy loss for classification of exercise intensity categories. The server computes gradients of the loss function with respect to model parameters using backpropagation, and updates the parameters using an optimization algorithm such as stochastic gradient descent or an adaptive method. For the emotion analysis algorithm, the server trains the model on labeled text data with known emotional categories, using similar loss functions and optimization methods. For the semantic embedding used in meal-item matching, the server may employ contrastive learning or metric learning, where dish descriptions and item descriptions that correspond are trained to be closer in embedding space than unrelated pairs. These training processes are performed offline or periodically, and the resulting model parameters are loaded by the server during online operation.

The server thereby implements processing flows that differ from simple automation of human decision making. Human nutritionists typically read user descriptions and manually craft recommendations case by case, whereas the server uses fixed feature extraction procedures, neural network-based transformations, and embedding-based similarity searches that operate in high-dimensional vector spaces. The server relies on consistent numerical representations and non-intuitive intermediate indices (such as exercise load indices and distribution-based emotion scores) that are specifically adapted for computational efficiency and stability in neural network input spaces. This non-conventional data representation and processing pipeline reduces variance in AI outputs, stabilizes training and inference, and improves scalability when the number of users increases.

In alternative embodiments, the server may employ different neural architectures or data structures while maintaining the same functional roles. For the generative AI model, the server may use a decoder-only transformer, an encoder-decoder transformer, or a recurrent network with attention, as long as the model accepts a prompt sentence and outputs token sequences. For the emotion analysis algorithm, the server may use a simpler classifier based on logistic regression over averaged embeddings when computational resources are limited. For the mapping to external article providing services, the server may use a hybrid approach combining rule-based filtering (for example, by dietary restrictions and allergies) with embedding similarity for final ranking. The server may also adjust feature sets and indices to accommodate additional signals such as wearable device data or physiological sensor readings.

By integrating these components and processing techniques, the server allows the terminal and the user to interact with a health support system that operates efficiently at scale, produces personalized and constraint-consistent recommendations, and directly interfaces with external article providing services in a machine-usable manner. The interplay of structured data storage, feature generation, controlled prompt sentence construction, generative AI inference, and embedding-based item mapping produces technical effects such as reduced latency, improved recommendation accuracy, reduced manual mapping errors, and enhanced utilization of computational resources.

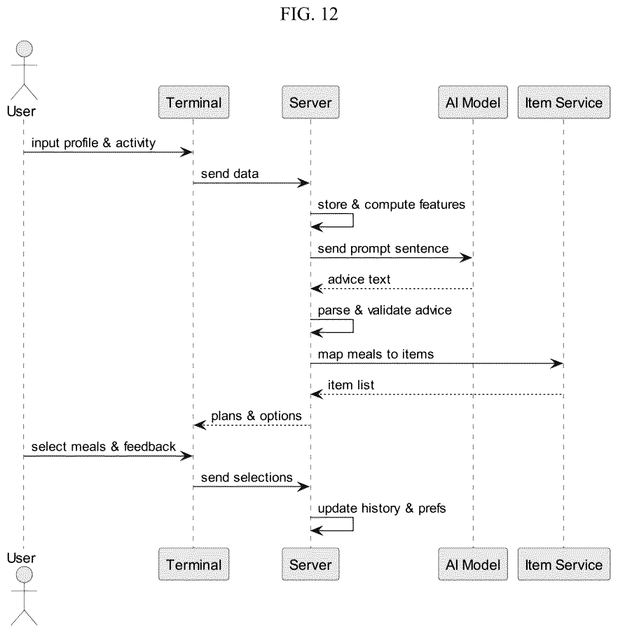

The following describes the processing flow using FIG. 12.

### Step 1:

The user operates the terminal to launch a health support application and to input basic attribute information. The terminal displays input fields for age, sex, body weight, height, and a target health state, along with optional dietary preferences and allergies. The input of the terminal is raw text and numeric values entered through the user interface. The terminal validates these inputs (for example, checking numeric ranges and required fields), converts them into a structured data object with typed fields, and outputs this structured basic attribute information for transmission to the server.

### Step 2:

The user operates the terminal to input lifestyle activity information. The terminal presents screens for recording meals (for example, dish names and portion sizes), sleep (bed time and wake time), exercise (exercise type, duration, and intensity), and emotional state (for example, selected from predefined emotion labels or entered as free text). The input to the terminal is event-level activity and emotion data. The terminal timestamps each entry, aggregates raw entries into daily summaries where appropriate (such as total calories per day if available, total sleep duration, and total exercise minutes), and outputs a structured representation of lifestyle activity information to the server.

### Step 3:

The terminal sends the structured basic attribute information and the structured lifestyle activity information to the server over a network. The input to the terminal at this step is the previously prepared structured data objects. The terminal packages these objects into a request message, attaches a user identifier or authentication token, and transmits the request via a secure communication protocol. The output of the terminal is a network message containing normalized user data addressed to the server.

### Step 4:

The server receives the request message containing basic attribute information and lifestyle activity information from the terminal. The input to the server is the received network payload. The server parses the payload, verifies the authenticity and integrity of the request, and maps the parsed fields into internal data structures. The server outputs these internal data structures as records ready to be written to a storage medium.

### Step 5:

The server stores the parsed basic attribute information and lifestyle activity information as structured data in a storage medium. The input to the server at this step is the internal data structures representing the user profile and daily activities. The server inserts or updates records in database tables or collections, assigning primary keys and foreign keys to link profiles and activity records to the user. The output of the server is a set of persistent records in the database that can be queried efficiently in later steps.

### Step 6:

The server performs statistical processing on the stored data to compute aggregated metrics. The input to the server is a set of user profile records and recent lifestyle activity records retrieved from the storage medium. The server calculates averages (for example, average daily calorie intake, average sleep duration, average weekly exercise time), sums (such as total steps per day if available), and variability measures (such as standard deviations of calorie intake and exercise duration). The server then writes these aggregated metrics back to the database as derived fields. The output of the server is an enriched dataset containing both raw records and computed statistical features.

### Step 7:

The server performs feature generation processing to produce a feature vector for model input. The input to the server is the enriched dataset including basic attribute information, lifestyle activity information, and aggregated metrics. The server normalizes numerical values (for example, scaling age, body mass index, and calorie values using predetermined means and standard deviations) and encodes categorical values (for example, converting sex, exercise type, and dietary preferences into one-hot or integer encodings). The server concatenates these normalized and encoded values into a fixed-length feature vector representing the user's current state. The output of the server is a machine-readable feature vector suitable for numerical computation.

### Step 8:

The server analyzes the emotional state of the user using an emotion analysis algorithm. The input to the server is emotional state data from the lifestyle activity information, which may include selected labels and free-text comments. The server tokenizes any free-text comments, maps tokens to embeddings using a pre-trained embedding model, and feeds the embeddings into a classifier model such as a neural network. The classifier outputs probabilities for multiple emotional categories or an emotional intensity score. The server converts these probabilities into an emotional state representation (for example, a primary label such as “stressed” with associated confidence) and stores this representation as part of the user's feature set. The output of the server is an analyzed emotional state feature that can be used both numerically and textually.

### Step 9:

The server calculates a nutrition index and an exercise index from the feature vector. The input to the server is the feature vector including demographic, lifestyle, and emotional features. The server applies one or more trained models (for example, feedforward neural networks or regression models) to the feature vector and computes target values such as recommended daily energy intake, macronutrient ratios, and recommended exercise amount and intensity. The server may apply activation functions and linear transformations as defined in the model parameters to obtain these indices. The output of the server is a set of numerical indices representing recommended nutrition and exercise targets for the user.

### Step 10:

The server generates a prompt sentence to control a generative AI model. The input to the server is the combination of basic attribute information, lifestyle activity summaries, analyzed emotional state, and the nutrition and exercise indices. The server formats this information into natural language text, including explicit numerical constraints and structural instructions. For example, the server generates a prompt sentence such as:

“The user is a 30-year-old female. Current weight is 70 kg, height is 165 cm. The target health state is to lose 5 kg in 3 months while maintaining muscle mass. The average daily energy intake over the last 7 days is approximately 2200 kcal. The average sleep duration is 7 hours per night. The user performs light walking about 6000 steps per day. The analyzed emotional state is ‘slightly stressed’ with a tendency to snack late at night. Based on these conditions, generate a 7-day meal plan with three meals and one snack per day. Each day should have a total energy intake between 1500 and 1700 kcal, with a high-protein, moderate-carbohydrate, low-fat nutrient balance. Express the meals using realistic dishes that can be prepared by common food providers. Also include a brief explanation for each day describing how the meals support gradual weight loss and stress control.”

The server outputs the fully constructed prompt sentence as a text string ready to be sent to the generative AI model.

### Step 11:

The server sends the prompt sentence to a generative AI model and configures generation parameters. The input to the server is the prompt sentence and configuration parameters such as maximum token length, temperature, and top-k or top-p values. The server calls an interface for the generative AI model, passing the prompt sentence and parameters as arguments. The generative AI model internally performs token-level computations using its neural network architecture to generate output text. The output of the server at this step is a request to the model and, after waiting for completion, the receipt of the generated advice information as a text response.

### Step 12:

The server parses the advice information generated by the generative AI model. The input to the server is the raw output text containing meal plans, explanations, and possibly exercise plans. The server applies a parsing procedure that identifies day delimiters, meal labels (for example, “Breakfast”, “Lunch”, “Dinner”, “Snack”), nutrient values, and exercise descriptions. The server may use pattern matching, predefined markers required by the prompt sentence, and simple natural language parsing rules to extract structured elements. The output of the server is a structured representation of the advice, including a daily meal plan with dishes and nutrient data, and an exercise plan with activity types and durations.

### Step 13:

The server validates the extracted meal plan and exercise plan against the indices and constraints. The input to the server is the structured advice representation and the previously computed nutrition index and exercise index. The server sums the calories of each day's meals, calculates macronutrient percentages, and compares these values to the target ranges specified by the nutrition index. The server also evaluates whether the suggested exercise durations and intensities fall within safe and recommended ranges defined by the exercise index. If values fall outside allowed ranges, the server flags the advice as inconsistent. The server may then generate a modified prompt sentence, explicitly stating needed corrections, and repeat the interaction with the generative AI model. The output of the server is a validated and, if needed, corrected advice dataset.

### Step 14:

The server maps the validated meal plan to item information of an external article providing service. The input to the server is the list of generated dishes and a catalog of items with identifiers, descriptions, and optional nutrient data. The server converts dish names and catalog descriptions into vector embeddings and computes similarity scores between each dish embedding and each item embedding. The server selects the top-ranked items exceeding a similarity threshold for each dish and associates dish descriptions with specific item identifiers. The output of the server is a set of selectable meal options, each linking a generated dish to one or more catalog items, including price and availability information when available.

### Step 15:

The server assembles a response payload for the terminal. The input to the server is the validated meal plan, the mapped selectable meal options, and the exercise plan. The server constructs a structured response that includes, for each day, the recommended meals, mapped items, nutrient summaries, and exercise instructions, along with explanatory text. The server may also include metadata such as total calories per day, estimated preparation or delivery times, and indicators of emotional-state-aware advice. The output of the server is a response message ready for transmission to the terminal.

### Step 16:

The terminal receives the response payload and renders it for the user. The input to the terminal is the structured response message from the server. The terminal parses the response, updates its user interface, and displays daily meal schedules, selectable items, nutrient summaries, and exercise suggestions. The terminal may provide interactive elements such as buttons for selecting meals for ordering or saving exercise plans. The output of the terminal is a visual and interactive representation of the advice information that the user can understand and manipulate.

### Step 17:

The user operates the terminal to select meal options and optionally to accept or modify exercise plans. The input to the user is the displayed meal and exercise information. The user taps or clicks on selection controls to choose specific meals for ordering, to reject certain dishes, or to adjust exercise suggestions. The terminal records these selection operations as structured data objects that capture chosen items, rejected items, and any modifications. The output of the user's actions is a set of selection and modification records within the terminal.

### Step 18:

The terminal sends the user's selection operations and feedback information to the server. The input to the terminal is the recorded selection records and any feedback such as ratings or comments entered by the user. The terminal packages these into a request payload, associates them with the user identifier, and transmits the payload to the server using a secure communication channel. The output of the terminal is a network message containing selection history and feedback data.

### Step 19:

The server receives the selection history and feedback information and updates the storage medium. The input to the server is the payload including selected item identifiers, rejection events, ratings, and free-text comments. The server parses the payload and writes new records into tables for selection history and feedback, linking them to corresponding advice entries and user identifiers. The server may also compute preference features, such as preferred cuisines, disliked ingredients, and sensitivity to certain nutrient patterns, by aggregating past selections and ratings. The output of the server is an updated database state that includes both raw interaction logs and derived preference indicators.

### Step 20:

The server incorporates the selection history and feedback information into future feature generation and prompt sentence construction. The input to the server is the updated database state, including preference indicators. The server extends the feature vector to include preference-related components, such as a vector of cuisine affinities or a penalty score for disliked attributes. The server also adapts future prompt sentences by adding explicit constraints derived from these preferences, for example specifying that spicy foods should be avoided or that portion sizes should be larger or smaller. The output of the server is a refined feature vector and future prompt sentences that are more closely tailored to the user's preferences and interaction history.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional health coaching and wellness-support systems that utilize information technology generally suffer from several technical deficiencies in how user data is processed and how personalized advice is generated. First, typical systems merely collect static user attributes and recent activity logs and apply fixed rule-based logic or simple scoring schemes. Such systems do not effectively transform heterogeneous, time-series lifestyle data into machine-interpretable representations, and therefore cannot robustly handle noisy inputs, missing values, or long-term behavioral trends. As a result, these systems exhibit limited scalability and accuracy when deployed for a large number of users with diverse behaviors. Second, in systems that do apply machine learning, the evaluation model and the natural-language output component are often loosely coupled. The evaluation model may output risk scores or classification labels, but the subsequent advice generation is frequently implemented as handcrafted templates or pre-defined text snippets. This leads to a technical bottleneck in the data processing pipeline because the rich, high-dimensional intermediate results of the machine learning model are not directly and flexibly leveraged to guide natural-language generation. The inability to systematically convert structured analysis results into effective prompts for a generative AI model results in underutilization of computational resources and degraded personalization quality.

Third, existing systems typically do not incorporate the user's emotional state as a first-class computational parameter in the advice generation pipeline. Even when some form of sentiment or mood detection is available, it is commonly used only for superficial presentation changes at the user interface layer. There is no integrated mechanism for using the estimated emotional state to programmatically adjust the content, tone, or load level of recommended actions at the level of prompts and model inputs. Consequently, advice may be technically correct but poorly timed or inappropriate in intensity, leading to low adherence and reduced overall system effectiveness.

Fourth, many systems treat the user's subsequent feedback and execution status merely as additional passive logs, without closing the loop in the computational pipeline. Execution data is rarely reintegrated as time-series state information in a systematic way that influences subsequent feature extraction, risk evaluation, and prompt construction. This lack of a closed feedback loop prevents the system from functioning as an adaptive, stateful computing apparatus that can refine its behavior over time based on actual user responses. Accordingly, there is a need for improved computer-implemented techniques and system architectures that (i) consistently acquire and store heterogeneous user attribute information and time-series state information, (ii) transform such information into structured feature values suitable for machine-learning-based risk evaluation, (iii) automatically construct prompt sentences that encode both evaluation results and output constraints for a generative AI model, (iv) dynamically personalize those prompts and resulting advice based on an estimated emotional state of the user, and (v) integrate user execution status back into the time-series information as part of a continuous, adaptive computing loop. By solving these technical problems, the invention improves the functioning of the computer-based health coaching system itself, yielding more reliable processing of complex behavior data, more effective utilization of generative AI models, and more contextually appropriate, user-tailored outputs.

The specific processing by the specific processing unit 290 of the data processing device 12 in Example 2 is realized by the following means.

The present invention provides a server comprising a processor and a storage device, the processor being configured to (i) acquire, via a client terminal, user attribute information including at least a target state, age, sex, and body weight, and time-series state information including at least meal information, sleep information, physical activity information, and psychological state information, and to store the acquired information in the storage device as structured records, (ii) generate, for each user, aggregated information that includes a history of the time-series state information, perform numerical computation and statistical processing on the aggregated information to extract feature values including index values of sleep amount, physical activity amount, and eating habits as well as temporal change amounts thereof, and input the feature values to an evaluation model implemented by a machine learning algorithm to obtain analysis result data representing health risks and lifestyle items requiring improvement, (iii) construct, based on the analysis result data, the attribute information, and the time-series state information, a prompt sentence to be input to a generative AI model, the prompt sentence describing the analysis result data in a natural language and further specifying constraints for the generative AI model including a target advice domain, an expression style, a level of detail, and a temporal planning horizon, (iv) apply an emotion estimation component to classify an emotional state of the user from the psychological state information and subjective input information obtained from the client terminal, and programmatically modify at least one of the expression style and load level of recommended actions within the prompt sentence in accordance with the classified emotional state, (v) input the resulting prompt sentence to the generative AI model, receive from the generative AI model a health-related advice text in natural language, and post-process the advice text together with the analysis result data to generate advice information including at least summary information, concrete action items, and key improvement areas, and (vi) transmit the advice information to the client terminal and control the client terminal so that the advice information is hierarchically displayed and that execution status input from the user is stored again as part of the time-series state information in the storage device. This enables the underlying computer system to more effectively transform heterogeneous lifestyle data into machine-learning features, to tightly couple learned evaluation outputs with prompt sentences that drive a generative AI model, to dynamically adapt generated advice based on an automatically estimated emotional state, and to operate as a closed-loop, stateful processing pipeline that continuously updates and refines its health-coaching outputs based on user behavior, thereby improving the technical performance and personalization capability of the health coaching platform.

The term “attribute information” refers to user-related descriptive information including at least a target state desired by the user, age, sex, body weight, and other user attributes that are used as input variables for analysis and advice generation.

The term “time-series state information” refers to information representing the user's state or behavior over time, including at least meal information, sleep information, physical activity information, psychological state information, and histories thereof, which is recorded with temporal ordering.

The term “terminal device” refers to an information processing apparatus operated by the user, such as a portable communication device, a personal computer, or another client device, that is configured to transmit user information to the server and to display advice information received from the server.

The term “storage device” refers to any computer-readable storage medium, such as a non-volatile memory, a magnetic storage unit, an optical storage unit, or a solid-state storage unit, that stores attribute information, time-series state information, aggregated information, analysis result data, and advice information.

The term “aggregated information” refers to information generated per user by combining and summarizing multiple items of time-series state information, including a history of the time-series state information and derived summary values used for further analysis.

The term “feature values” refers to numerical or categorical values derived from attribute information and time-series state information, including index values of sleep amount, physical activity amount, and eating habits, as well as temporal change amounts thereof, which are used as inputs to an evaluation model.

The term “index values” refers to numerical indicators calculated from raw data, such as average sleep duration, total physical activity amount, or frequency of late-night meals, that quantitatively describe aspects of the user's lifestyle.

The term “temporal change amounts” refers to values representing changes of index values over time, such as increases or decreases in sleep duration, changes in physical activity level, or trends in eating habits across a predetermined period.

The term “evaluation model” refers to a computational model implemented using a machine learning algorithm, which receives feature values as input and outputs analysis result data such as health risks and lifestyle items requiring improvement.

The term “machine learning algorithm” refers to a computational procedure that learns a relationship between input data and output data from training examples, and that is used to implement the evaluation model for predicting health-related metrics, risks, and classifications.

The term “analysis result data” refers to structured data output from the evaluation model, including at least one health risk indicator and at least one lifestyle item requiring improvement for the user, which serve as a basis for generating advice.

The term “generative artificial intelligence model” refers to an artificial intelligence model configured to receive a text input and to generate natural language text as output, based on probabilistic language modeling or similar generative techniques.

The term “prompt sentence” refers to a natural language text generated by the processor and provided as input to the generative artificial intelligence model, the text including descriptions of analysis result data and constraints or conditions on the desired output.

The term “target advice domain” refers to a field or category of the advice to be generated, such as sleep, exercise, diet, stress management, or combinations thereof, as specified within the prompt sentence.

The term “expression style” refers to stylistic attributes of the natural language output of the generative artificial intelligence model, including tone, formality level, directness, and structure, as specified or influenced by the prompt sentence.

The term “level of detail” refers to the granularity and amount of information requested from the generative artificial intelligence model, such as high-level summary advice or step-by-step, detailed guidance.

The term “temporal planning horizon” refers to a time range for which the advice or plan generated by the generative artificial intelligence model is intended to apply, such as daily, weekly, or monthly scopes.

The term “health-related advice text” refers to natural language text generated by the generative artificial intelligence model that provides recommendations, suggestions, or guidance relating to the user's health or lifestyle.

The term “advice information” refers to structured information generated from the health-related advice text and analysis result data, including at least summary information, specific action items, and key improvement areas.

The term “summary information” refers to a concise natural language representation of the main points or overall recommendations contained within the advice information.

The term “specific action items” refers to concrete, executable tasks or behaviors described in the advice information that the user is encouraged to perform, such as defined exercise routines or sleep schedule adjustments.

The term “key improvement areas” refers to prioritized lifestyle domains or behaviors that have been identified as needing improvement, such as insufficient sleep, low physical activity, or unhealthy eating habits.

The term “emotion estimation component” refers to a functional module configured to estimate or classify an emotional state of the user based on psychological state information, subjective input, and optionally other signals.

The term “emotional state” refers to an internal psychological condition of the user, such as stress level, motivation level, mood, or similar affective status, which can influence the suitability and presentation of advice.

The term “subjective input information” refers to user-provided data describing personal perceptions or feelings, such as self-reported mood, fatigue, or perceived stress, entered through the terminal device.

The term “load level of recommended actions” refers to the intensity or burden of the actions proposed to the user, including factors such as duration, frequency, physical effort, or required lifestyle change.

The term “execution status” refers to information indicating whether and to what extent the user has carried out one or more specific action items included in previously provided advice information.

The term “hierarchical display” refers to a presentation format on the terminal device in which summary information, specific action items, and key improvement areas are shown in a layered or structured manner, such as via sections, lists, or expandable items that reflect logical relationships among elements.

In one embodiment, a server cooperates with one or more terminals used by a user to implement an AI-based health coaching system. The server includes at least one processor, a main memory, a non-volatile storage device, and a network interface. The processor may be a general-purpose central processing unit or a graphics processing unit. The terminal may be a smartphone, a tablet computer, or a personal computer, and includes a display, an input interface, a local memory, and a communication module.

The terminal executes an application program that provides user interfaces for input and display. The terminal transmits user attribute information and time-series state information to the server, receives advice information from the server, and renders the advice information on the display. The server executes multiple software modules including a data ingestion module, a data normalization module, a feature extraction module, a machine-learning-based evaluation module, a prompt generation module, a generative AI interaction module, an emotion estimation module, and an advice formatting and delivery module.

The server uses an operating system such as a general-purpose server operating system. The server uses a database management system such as a relational database to store structured records. The server uses numerical computation libraries such as matrix and vector processing libraries to perform numerical operations and statistical analyses. The server uses a machine learning framework such as a tensor computation framework to implement the evaluation model and to train or update the evaluation model. The server uses a neural-network library or a generative model API to access a generative AI model that implements a transformer-based architecture.

The server stores, in the storage device, a schema defining data structures for user attribute information, time-series state information, aggregated information, feature values, analysis result data, emotion state labels, and advice information. For example, the server stores user attribute information in a table that includes fields such as user identifier, target state descriptor, age, sex code, and body weight. The server stores time-series state information in a table that includes fields such as timestamp, meal type code, caloric estimate, sleep duration, sleep start time, sleep quality score, physical activity duration, step count, and psychological state rating. By storing time-series state information with timestamps and normalized codes, the server enables efficient retrieval and indexing for subsequent feature extraction. The server uses the data normalization module to convert heterogeneous raw values into a consistent representation. For example, the server converts sleep durations into a floating-point number of hours, converts physical activity data into standardized units such as estimated metabolic equivalent minutes, and encodes categorical inputs such as meal type into one-hot or integer codes. The server uses this normalization to reduce variance due to different input formats and to allow the evaluation model to operate on stable, well-defined feature distributions. This normalization improves computational efficiency and reduces numerical error propagation in subsequent stages.

The server uses the feature extraction module to derive feature values from both current and historical time-series state information. The server computes index values such as average nightly sleep duration over the past seven days, standard deviation of sleep onset times over the past week, total weekly physical activity minutes, and frequency of late-night meals over a rolling window. The server further computes temporal change amounts by comparing these index values between different time windows, such as the most recent week versus the prior week. The server represents these feature values as a fixed-length vector that serves as input to the evaluation model. This structured feature vector enables the evaluation model to capture temporal patterns and trends that are not visible from single-day data, thereby improving the accuracy and robustness of risk estimation.

The server implements the evaluation model as a trained neural network model in a machine learning framework. In one example, the server implements the evaluation model as a feedforward neural network with multiple fully connected layers and non-linear activation functions. The input layer receives the feature vector. Intermediate layers apply weighted linear transformations and activation functions such as rectified linear units, followed by normalization layers and dropout layers. The output layer generates continuous risk scores and discrete labels corresponding to health risks and lifestyle items requiring improvement. The server stores trained weight parameters of the evaluation model in the storage device and loads them into main memory at runtime.

The server trains the evaluation model in advance using training data sets that include historical feature vectors and ground-truth labels or target values. The server defines a loss function such as a combination of mean squared error for continuous risk scores and cross-entropy loss for categorical labels. The server uses an optimization algorithm such as stochastic gradient descent or an adaptive gradient-based method to update the weights of the evaluation model. The server computes gradients of the loss function with respect to the model parameters and updates the parameters iteratively until convergence criteria are met. The server may perform data augmentation by adding small perturbations to input feature values within allowable ranges, by sampling different time windows, or by augmenting underrepresented classes to improve generalization performance. By explicitly defining the loss function and weight update procedure, the server improves predictive accuracy and stabilizes the behavior of the evaluation model across diverse user patterns.

The server uses the emotion estimation module to estimate an emotional state of the user. In one embodiment, the server implements the emotion estimation module as a classification model that receives psychological state ratings, self-reported mood values, and optionally textual descriptions from the user. The server encodes these inputs into numerical representations, and a neural network classifier outputs probabilities for emotional state categories such as high motivation, low motivation, high stress, or neutral. The server uses a softmax layer and selects the highest-probability category as the estimated emotional state. The server stores this emotional state label in the storage device and uses it to adjust prompt generation.

The server uses the analysis result data and the emotional state to generate a prompt sentence for a generative AI model. The server uses a prompt generation module that assembles predefined text templates with inserted variables. The server includes in the prompt sentence the following components: a description of user attributes, a summary of index values for sleep, physical activity, and diet, qualitative interpretations of risk levels (for example, high, moderate, or low), and constraints on the desired advice output. The server programmatically changes elements of the expression style, level of detail, and load level of recommended actions as a function of the emotional state. For example, for a user classified as low motivation, the server reduces the initial physical activity load in the recommended actions and requests more supportive and encouraging language in the prompt sentence.

The server generates, for example, a prompt sentence such as:

“The user is a 35-year-old male, weight 72 kg. Over the past 7 days, the user slept an average of 5 hours per night, did very little exercise (under 2,000 steps per day), and frequently eats late at night after 22:00. The machine learning evaluation shows a high risk related to sleep deprivation and a moderate risk related to lack of exercise. The user is currently in a low-motivation emotional state. As a generative AI model, generate clear and practical health advice in natural language. Focus on improving sleep habits and gradually increasing daily physical activity. Provide specific daily actions and a simple weekly plan that an ordinary person can follow. Use gentle and encouraging language and keep the initial physical effort low.”

In another example related to eating behavior under sleep shortage, the server generates a prompt sentence such as:

“The user is a 30-year-old female, weight 60 kg. In the past 7 days, the user slept an average of 5 hours per night and often feels hungry late at night. The evaluation model indicates a high risk related to increased appetite and late-night snacking. As a generative AI model, generate concrete and easy-to-implement advice for meals and snacks that help suppress appetite when sleep is insufficient. Include specific examples of foods and timing, and explain briefly why each recommendation is helpful.”

In a further example focused on reduced exercise, the server generates a prompt sentence such as:

“The user is a 42-year-old male, office worker, weight 80 kg. Over the past 4 weeks, the average daily step count decreased from 7,000 steps to 2,500 steps. The evaluation model indicates a moderate risk related to lack of physical activity. As a generative AI model, generate practical and safe health advice in natural language to increase daily physical activity. Include specific examples such as walking routines, simple desk exercises, and weekend activity ideas. Explain each recommendation briefly.”

The server sends the generated prompt sentence to a generative AI model. In one embodiment, the generative AI model is a transformer-based language model deployed on a remote computing resource or on another server. The generative AI model includes an encoder-decoder or decoder-only architecture with self-attention layers, feedforward layers, and positional encodings. The server transmits the prompt sentence as plain text to an API interface of the generative AI model, along with parameters such as maximum token length, temperature, and top-p values. The generative AI model tokenizes the prompt sentence, applies multi-head attention computations and feedforward transformations at each layer, and generates a sequence of output tokens corresponding to the health-related advice text. The server receives the generated health-related advice text, reconstructs it as a natural language string, and performs post-processing. The server may remove redundant segments, check for prohibited expressions, and, if needed, append disclaimers indicating non-medical nature. The server aligns segments of the advice text with corresponding portions of the analysis result data. For example, the server tags certain recommendations as primarily related to sleep improvement, others as related to physical activity, and others as related to diet. The server stores this structured advice information in the storage device in a dedicated table that contains fields for summary information, specific action items, and key improvement areas. The terminal receives the advice information and displays it in a hierarchical format. The terminal, for example, displays summary information at the top of the screen, followed by expandable sections for each key improvement area. Within each section, the terminal lists specific action items with checkboxes. The user can mark an action as completed by tapping the corresponding checkbox. The terminal records execution status and transmits updated execution records back to the server. The server stores these execution records as additional time-series state information, including timestamps and references to the corresponding action items.

By reintegrating execution status into time-series state information, the server closes a feedback loop that allows the evaluation model and the prompt generation module to adapt over time. The server can modify feature extraction to include adherence metrics, such as the percentage of recommended actions executed in a week, and can feed these metrics into the evaluation model as additional feature values. This configuration enables the system to distinguish between persistent behavioral constraints and transient deviations, improving prediction accuracy and the calibration of advice intensity.

The described architecture provides technical improvements over conventional systems. The server reduces communication load between the terminal and the server by transmitting compact, structured feature values and identifiers, instead of sending large raw logs repeatedly. The server executes feature extraction and evaluation on the server side using optimized numerical libraries, which reduces processing load on the terminal and enables consistent performance across different terminal types. By using a fixed-length feature vector representation and a trained evaluation model, the server can process large numbers of users concurrently with predictable computational complexity, thereby improving scalability and throughput.

The server achieves improved accuracy by leveraging time-series aggregation and temporal change amounts, which capture dynamic patterns that are not available in systems using only static or single-snapshot data. The server further achieves improved personalization due to the integration of emotional state estimates into the prompt generation process. Unlike human operators or simple rule-based systems, the server applies a systematic, model-driven adjustment of expression style and load level of recommended actions at the level of the prompt sentence for the generative AI model. This non-conventional integration of evaluation model outputs, emotional state classification, and generative AI prompts results in more context-appropriate and actionable advice.

The server employs non-traditional rules and processing flows that differ from manual coaching workflows. Instead of directly mapping raw inputs to advice templates, the server decomposes processing into normalization, feature extraction, evaluation, emotion estimation, and prompt construction. The server uses the evaluation model and emotion estimation model to compute internal representations and control signals that cannot be feasibly computed or updated by human operators in real time at scale. These internal representations guide both the content and style of generative outputs, enabling intricate interactions among multiple model outputs that constitute an improvement in machine-based reasoning and text generation.

The training procedures applied to the evaluation model and, in some embodiments, to the emotion estimation model, also contribute to technical effectiveness. By defining specific loss functions that penalize misclassification of risk and inaccurate estimation of behavioral trends, and by performing iterative gradient-based optimization with regularization techniques, the server reduces generalization error and improves robustness against noisy or incomplete data. This leads to a lower rate of erroneous risk assessments and inappropriate advice, which is a technical effect measurable at the level of system outputs.

The system may be implemented in various alternative embodiments. In one embodiment, the evaluation model may be replaced with a recurrent neural network or a temporal convolutional network that directly ingests sequences of time-series state information instead of aggregated feature vectors. In another embodiment, the generative AI model may be deployed locally on the same server using a model-serving framework, thereby reducing network latency and increasing control over inference parameters. In a further embodiment, the emotion estimation module may incorporate voice features or facial expression data captured via the terminal, provided appropriate privacy safeguards are in place, to improve the accuracy of emotional state classification.

In each embodiment, the server maintains the same fundamental data structures for attribute information, time-series state information, aggregated information, feature values, analysis result data, emotion labels, prompt sentences, and advice information. The server uses these data structures to coordinate the flow of information between modules and to maintain consistent associations between inputs, internal states, and outputs. This structured data flow, coupled with defined machine learning models, prompt generation rules, and hierarchical display formats, enables other practitioners to implement the invention and to integrate it with various hardware and software configurations, while preserving the claimed technical advantages.

Through these arrangements, the server, together with the terminal and user interactions, implements more than a mere automation of human coaching tasks. The server implements specific, optimized computational processes that improve data management, prediction accuracy, advice personalization, and system scalability. The generative AI model and the evaluation model are not treated as opaque or generic components; rather, their structures, training procedures, and interconnections are explicitly designed to enhance the operation of the computer-implemented health coaching system itself.

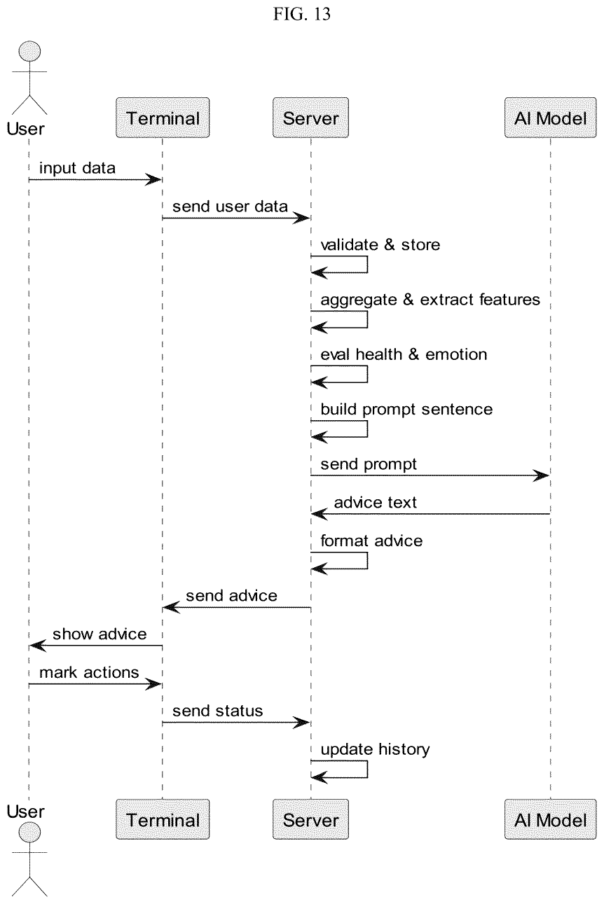

The following describes the processing flow using FIG. 13.

### Step 1:

The user operates the terminal to input health-related data. The user launches an application on the terminal and enters attribute information (target state, age, sex, body weight) and time-series state information (meal contents, sleep duration, bed time, wake time, physical activity duration, step count, psychological state rating). The input of this step is raw textual and numerical values typed or selected by the user. The output of this step is a set of structured key-value pairs temporarily held in the terminal's memory.

### Step 2:

The terminal validates and structures the user input. The terminal checks that required fields are present, verifies basic ranges (for example, age >0, sleep duration between 0 and 24 hours), and converts date/time strings to standardized timestamp formats. Based on the validated values, the terminal constructs a structured data object, such as a JSON object containing user identifier, timestamps, and the input fields. The input of this step is the raw key-value pairs from Step 1. The output of this step is a normalized, machine-readable data object prepared for transmission.

### Step 3:

The terminal transmits the structured data object to the server. The terminal opens a secure network connection, attaches authentication information, and sends an HTTP request whose body contains the structured data object. The input of this step is the normalized data object from Step 2. The output of this step is a network message containing the user's attribute information and time-series state information delivered to the server.

### Step 4:

The server receives and parses the network message. The server uses a web framework to accept the HTTP request, verifies the authentication token, and reads the request body. The server parses the structured data object into internal data structures such as dictionaries or records in main memory. The input of this step is the network message from Step 3. The output of this step is an in-memory representation of the user's attribute information and time-series state information.

### Step 5:

The server validates and normalizes the received data. The server checks for missing fields, enforces value constraints (for example, weight within a plausible range, step counts non-negative), and logs any anomalies. The server converts heterogeneous units into consistent numerical formats, such as converting sleep durations to floating-point hours, physical activity to standardized units, and categorical items to integer or one-hot codes. The input of this step is the in-memory data from Step 4. The output of this step is a set of cleaned and normalized values suitable for storage and further computation.

### Step 6:

The server stores the normalized data in a storage device. The server maps the normalized values to database tables for attribute information and time-series state information, associating them with a user identifier and timestamps. The server executes database insert or update operations so that the new records are persisted. The input of this step is the cleaned and normalized values from Step 5. The output of this step is a set of persistent records representing the latest user data in the database.

### Step 7:

The server retrieves historical records to generate aggregated information. The server queries the database for prior time-series state information for the same user within one or more defined windows, such as the past 7 days or 30 days. The server loads these historical records into memory and constructs aggregated information including sequences of sleep durations, sequences of physical activity amounts, and counts of late-night meals. The input of this step is the user identifier and the database contents from Step 6. The output of this step is aggregated information that combines the latest and past records in chronological order.

### Step 8:

The server performs feature extraction from aggregated information. The server uses numerical computation routines to compute statistical measures such as means, standard deviations, maximums, minimums, and trend slopes for sleep, physical activity, and eating habits. The server also calculates temporal change amounts by subtracting values from consecutive time windows (for example, recent week minus previous week). The server arranges these derived numbers and categorical encodings into a fixed-length feature vector.

The input of this step is the aggregated information from Step 7. The output of this step is a feature vector representing the user's behavioral and lifestyle patterns.

### Step 9:

The server evaluates health-related risks using an evaluation model. The server loads a pre-trained neural network model from storage into memory and feeds the feature vector to the input layer. The server performs forward propagation through the network by computing weighted sums and activation functions in each layer. As a result, the server obtains numerical outputs such as risk scores for sleep deprivation, insufficient physical activity, and unhealthy eating patterns, as well as predicted labels for lifestyle items requiring improvement. The input of this step is the feature vector from Step 8. The output of this step is analysis result data consisting of risk scores, labels, and intermediate confidence values.

### Step 10:

The server estimates the user's emotional state. The server applies an emotion estimation model, which may be a classification neural network or similar algorithm, to psychological state ratings and subjective inputs obtained from the user. The server encodes these inputs as numerical vectors and processes them through the emotion estimation model to produce probabilities for predefined emotion categories, such as high motivation, low motivation, high stress, or neutral. The server selects the highest-probability category as the current emotional state. The input of this step is the psychological state information from the time-series data together with any recent subjective inputs. The output of this step is an emotional state label associated with the user.

### Step 11:

The server constructs a prompt sentence for a generative AI model. The server combines analysis result data, attribute information, and the emotional state label into a natural-language description. The server selects and fills a template that includes fields for user characteristics, statistical summaries, interpreted risk levels, and instructions regarding output style, level of detail, load level of recommended actions, and time horizon. The server adaptively modifies wording and requested intensity of actions according to the emotional state label. The input of this step is the analysis result data from Step 9, the attribute information from storage, and the emotional state label from Step 10. The output of this step is a prompt sentence in natural language tailored to the current user and context.

### Step 12:

The server sends the prompt sentence to a generative AI model and obtains a generated text. The server invokes an API or local inference engine for the generative AI model and passes the prompt sentence, together with generation parameters such as maximum length and randomness controls. The generative AI model tokenizes the prompt and processes it through its transformer layers to produce a sequence of tokens representing health-related advice. The server receives this sequence, decodes it into natural-language text, and stores it temporarily in memory. The input of this step is the prompt sentence from Step 11. The output of this step is a raw health-related advice text generated by the generative AI model.

### Step 13:

The server post-processes the generated advice text and creates structured advice information. The server examines the generated text for coherence and removes or flags any inappropriate or irrelevant segments according to predefined rules. The server identifies sentences related to different domains (sleep, exercise, diet) by keyword or pattern matching and groups them. The server composes summary information by extracting or generating a concise description of the main recommendations, isolates specific action items as separate entries, and identifies key improvement areas based on the strongest risks from the analysis result data. The input of this step is the raw advice text from Step 12 and the analysis result data from Step 9. The output of this step is advice information containing summary information, specific action items, and key improvement areas.

### Step 14:

The server stores and transmits the advice information to the terminal. The server writes the advice information into the storage device, associating it with the user identifier and a timestamp for later reference. The server then formats the advice information as a response payload and sends it back to the terminal over the network. The input of this step is the structured advice information from Step 13. The output of this step is a network response message delivered to the terminal containing the advice information.

### Step 15:

The terminal receives and displays the advice information. The terminal parses the response payload, extracts the summary information, specific action items, and key improvement areas, and renders them on the display in a hierarchical layout. The terminal may show the summary at the top, the key improvement areas as headings, and the specific action items as selectable or checkable list elements. The input of this step is the network response message from Step 14. The output of this step is a visual presentation of the advice on the terminal's display.

### Step 16:

The user reviews and interacts with the displayed advice. The user reads the summary and detail sections, taps to expand or collapse sections, and uses checkboxes or buttons to indicate completion of specific action items, such as “walk 30 minutes today” or “go to bed before 23:00.” The input of this step is the visualized advice information from Step 15. The output of this step is user interaction data indicating which actions have been executed or acknowledged.

### Step 17:

The terminal records execution status and sends it to the server. The terminal logs user interactions, including timestamps and identifiers of the action items marked as completed. The terminal constructs an execution status object representing the user's adherence to recommended actions and transmits this object to the server as additional time-series state information. The input of this step is the user interaction data from Step 16. The output of this step is a network message carrying updated execution status to the server.

### Step 18:

The server incorporates execution status into time-series state information for future analyses. The server receives the execution status message, parses it, and stores it as part of the user's time-series state records in the database, linking it to the corresponding action items and advice session. The server can later use these records as inputs to the aggregation and feature extraction processes, thereby influencing subsequent evaluation model outputs and prompt sentence construction. The input of this step is the execution status message from Step 17. The output of this step is an updated set of persistent time-series records that include both spontaneous user data and adherence data, enabling an adaptive and continuously improving health coaching process.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented healthcare coaching systems generally adopt a static, rule-based architecture in which a processor executes predetermined decision trees over user profile data and simple activity logs. Such architectures exhibit several technical limitations from the viewpoint of information-processing technology.

First, conventional systems store user data in a database but treat the stored data only as passive records. They do not implement an integrated pipeline that converts heterogeneous user inputs-such as numeric sensor streams, categorical profile attributes, free-text comments, and external order statuses-into normalized feature vectors suitable for machine-learning inference and dynamic prompt generation. As a result, the processor cannot efficiently leverage large volumes of time-series data, and system resources are underutilized. Second, conventional systems that call generative artificial-intelligence models typically embed handcrafted prompts directly into application code. The prompts are not automatically derived from structured health-state information, fine-grained emotion states, and short-term biometric indicators. This leads to brittle behavior: even when the underlying generative model is powerful, the system cannot adapt the prompt content to changing sensor streams or historical engagement patterns, and the quality and stability of generated advice are inconsistent. From a computer-technology perspective, the absence of a feedback loop between stored data, feature extraction, model inference, prompt-sentence generation, and logging prevents the system from improving its own behavior over time.

Third, conventional architectures isolate health analysis from downstream actuation such as automated ordering from delivery services. Even if a system can recommend meals, it often provides only static text. The processor does not perform structured matching between generated diet descriptions and item catalogs of external delivery-service apparatuses, does not construct machine-readable order payloads compatible with heterogeneous external communication interfaces, and does not maintain unified history records that tie together prompts, generative-model outputs, order states, and user responses. This fragmentation increases latency, processing overhead, and implementation complexity.

Fourth, most existing systems fail to process continuous biometric and activity-amount data in near real time for micro-intervention purposes. While raw heart-rate or step data may be logged, the processor does not derive short-term indicators such as sitting duration or heart-rate variability, does not detect state changes based on these indicators, and does not dynamically generate short prompt sentences to request concise recommendations from a generative model. Consequently, the system cannot deliver low-latency, context-aware micro-interventions, and valuable streaming data are not exploited to improve interactive behavior. Fifth, conventional systems rarely close the loop by using accumulated prompt sentences, generative responses, inferred health states, emotion states, and user-response histories to retrain internal models and to refine prompt-generation logic. This lack of an integrated learning process at the system architecture level results in static behavior: the system cannot autonomously adapt to different populations, usage patterns, or changing model characteristics. From a computer-system design standpoint, this means that the processor does not implement mechanisms to periodically or conditionally update model parameters and prompt templates based on logged interaction data.

Accordingly, there is a need for a computer-implemented system in which a processor cooperates with a memory device to: (i) perform structured, multi-stage preprocessing of heterogeneous user data; (ii) generate context-dependent prompt sentences for generative artificial-intelligence models based on inferred health-state and emotion-state information; (iii) tightly couple generative outputs with downstream transactional processes such as automated item selection and order submission to external services; (iv) process continuous biometric streams for low-latency micro-interventions; and (v) execute on-going learning procedures that update both predictive models and prompt-sentence generation logic. Such a system should improve overall computational efficiency, adaptability, and responsiveness of AI-based health-support services, thereby constituting a concrete improvement in computer technology itself rather than merely automating a mental process.

The specific processing by the specific processing unit 290 of the data processing device 12 in Application Example 2 is realized by the following means.

The present invention provides a server comprising a memory device configured to store user information and a processor configured to access the memory device, wherein the processor is configured to perform operations that include: receiving, validating, and storing, in structured storage regions of the memory device, heterogeneous user data including basic attribute information and time-varying activity information; executing a data-preprocessing pipeline that normalizes numerical data, encodes categorical data, completes missing values, and generates feature values such as exercise indicators, sleep indicators, and energy-intake indicators; invoking at least one machine-learning model to infer health-state information from the feature values; invoking at least one emotion-analysis model to infer emotion information from at least a subset of the activity information and biometric or text information; generating context information that specifies one or more advice types and associated constraints based on the health-state information and the emotion information; dynamically composing a prompt sentence in natural language from the context information and transmitting the prompt sentence to a generative artificial-intelligence model; receiving a natural-language response from the generative artificial-intelligence model and parsing the response into structured advice information including at least one of an action plan, a diet menu, exercise content, sleep guidelines, and relaxation procedures; logging, in association, the prompt sentence and the structured advice information in the memory device as interaction history; mapping diet portions of the advice information to concrete items in an external delivery-service catalog by algorithmically selecting items based on dish descriptors, nutritional attributes, and energy amounts, and constructing and transmitting order information compatible with a communication interface of an external delivery-service apparatus; analyzing continuous biometric or activity-amount data at predetermined intervals to compute short-term indicators, detecting user-state changes based on the indicators, and, upon detection, dynamically generating short prompt sentences and obtaining corresponding micro-intervention proposals from the generative artificial-intelligence model for immediate delivery to user terminals; and periodically or conditionally executing a learning process that updates at least one predictive model and at least one prompt-sentence generation template based on accumulated activity information, health-state information, emotion information, prompt sentences, advice information, and user-response histories stored in the memory device. This enables an integrated computing architecture in which the server transforms raw, heterogeneous user data into machine-learning-ready feature representations, generates and refines context-aware prompt sentences for generative models, couples generated content with transactional processes and real-time micro-interventions, and continuously adapts its own models and prompt logic based on logged interactions, thereby improving the technical performance, adaptability, and responsiveness of computer-implemented health-support systems.

The term “memory device” refers to a hardware storage component, such as a semiconductor memory or magnetic storage, configured to store digital data including user information, feature values, model outputs, and interaction histories in a non-transitory manner.

The term “processor” refers to a hardware computing unit, such as a central processing unit or a processing core, configured to execute program instructions to perform data acquisition, preprocessing, model inference, prompt generation, external communication, and learning operations.

The term “user information” refers to data associated with an individual user, including at least basic attribute information and time-varying activity information managed by the system.

The term “basic attribute information” refers to relatively static profile data of a user, including at least a target state, age, sex, and weight.

The term “target state” refers to a desired condition of the user, including at least one of a health goal, a fitness goal, and a lifestyle goal, used as a basis for generating advice.

The term “activity information” refers to data that varies over time and represents daily behaviors and conditions of the user, including at least diet information, sleep information, exercise information, emotional-state information, biometric information, and behavior-history information.

The term “diet information” refers to activity information representing food and beverage intake of the user, including at least types of foods, quantities, times of intake, and estimated energy content.

The term “sleep information” refers to activity information representing sleep behavior of the user, including at least bedtimes, wake times, sleep durations, and sleep patterns.

The term “exercise information” refers to activity information representing physical activity of the user, including at least exercise types, exercise durations, intensities, and frequencies.

The term “emotional-state information” refers to activity information representing psychological or affective states of the user, including at least self-reported feelings, mood labels, and stress levels.

The term “biometric information” refers to physiological measurements of the user, including at least heart-rate data, heart-rate variability data, and sensor-derived indicators from wearable or embedded devices.

The term “behavior-history information” refers to records of past user actions within or outside the system, including at least interactions with the system, responses to advice, and historical activity patterns.

The term “validation” refers to processing that checks the format, range, consistency, and completeness of input data before the data are stored in the memory device.

The term “information storage region” refers to a logical or physical partition within the memory device, such as a database table or record structure, for storing a particular class of user information.

The term “data-preprocessing” refers to a sequence of computational operations applied to raw user data to produce standardized, machine-readable feature values for use by machine-learning models.

The term “normalization of numerical information” refers to transforming numerical values into a scaled or standardized range, such as by min-max scaling or z-score scaling, to stabilize model input magnitudes.

The term “encoding of categorical information” refers to converting non-numeric category values, such as sex or activity types, into numeric or structured representations, such as one-hot vectors or indices.

The term “completion of missing values” refers to estimating or substituting values for absent or incomplete data fields, using at least rule-based methods, statistical methods, or model-based imputation.

The term “moving average” refers to an aggregated value computed over a sliding time window, such as an average step count or sleep duration over a predefined number of days.

The term “feature value” refers to a numeric or structured variable derived from raw user data that is used as an input to a machine-learning model.

The term “exercise indicator” refers to a feature value that quantifies exercise behavior, including at least one of step counts, total exercise time, and exercise intensity scores.

The term “sleep indicator” refers to a feature value that quantifies sleep behavior, including at least one of sleep duration, sleep regularity, and sleep quality scores.

The term “energy-intake indicator” refers to a feature value that quantifies energy consumption, including at least one of daily total calories and macronutrient-based energy estimates.

The term “machine learning model” refers to a computational model whose parameters are derived from training data and that is configured to perform at least classification, regression, or prediction over feature values.

The term “health-state information” refers to data representing an inferred health condition of the user, including at least labels or scores indicating exercise sufficiency, sleep sufficiency, or energy balance.

The term “emotion-analysis model” refers to a software or algorithmic component configured to infer emotion information from at least text information, biometric information, or other emotion-related signals.

The term “emotion information” refers to data representing an inferred emotional state of the user and an associated intensity, including at least one of stress, joy, anxiety, and fatigue with corresponding confidence values.

The term “context information” refers to structured information generated by the processor that summarizes relevant user state, constraints, and desired output types for constructing a prompt sentence to a generative artificial-intelligence model.

The term “advice type” refers to a category of guidance to be provided to the user, including at least diet advice, exercise advice, sleep advice, mood-adjustment advice, and micro-break advice.

The term “prompt sentence” refers to a natural-language instruction or query generated by the processor and provided as input to a generative artificial-intelligence model to request generation of advice content.

The term “generative artificial-intelligence model” refers to a trained computational model that receives a prompt sentence and generates natural-language output or other structured content based on learned patterns, without relying solely on fixed rules.

The term “natural-language response” refers to text output generated by the generative artificial-intelligence model in response to a prompt sentence, expressed in a human-readable language.

The term “advice information” refers to structured or semi-structured data derived from the natural-language response of the generative artificial-intelligence model, including at least one of an action plan, a diet menu, exercise content, sleep guidelines, and relaxation procedures.

The term “action plan” refers to a set of recommended steps or routines over a specified time period for guiding the user toward a desired target state.

The term “diet menu” refers to a set of recommended meals or food combinations, including at least dish descriptions, timing, and nutritional characteristics.

The term “exercise content” refers to details of recommended physical activities, including at least exercise types, durations, frequencies, and intensities.

The term “sleep guidelines” refers to recommendations regarding sleep timing, duration, and sleep-related habits.

The term “relaxation procedures” refers to recommended techniques for reducing stress or improving emotional state, including at least breathing exercises, stretching routines, and relaxation practices.

The term “history information” refers to stored records that associate prompt sentences, model responses, advice information, and related metadata for later analysis and learning.

The term “external delivery-service apparatus” refers to an external computer system or service that provides item catalogs and performs order processing and delivery for physical items such as food.

The term “item information” refers to catalog data provided by an external delivery-service apparatus, including at least item identifiers, item names, descriptions, and nutritional attributes.

The term “delivery-target item” refers to an item selected from an external catalog as a candidate to fulfill a recommended diet menu.

The term “order information” refers to structured data representing a request to the external delivery-service apparatus, including at least item identifiers, quantities, destination information, and delivery conditions.

The term “communication interface” refers to a defined protocol and data format, such as an application programming interface, used to exchange messages between the system and an external delivery-service apparatus.

The term “user terminal” refers to an information-processing device operated by the user, including at least a portable information terminal, a stationary display device, or a wearable terminal.

The term “portable information terminal” refers to a handheld or mobile device, such as a smartphone or tablet, capable of running an application and communicating with the server.

The term “wearable terminal” refers to a device worn on the body or head of the user, such as smart glasses or a wrist-worn device, that can sense biometric data and present information.

The term “notification schedule” refers to timing information and rules for presenting alerts or reminders to the user terminal based on advice information or system events.

The term “progress status” refers to information indicating a current state of an external process, including at least order placement, preparation, dispatch, and delivery.

The term “continuous biometric information” refers to biometric measurements obtained in a time-continuous or high-frequency manner, including at least heart-rate streams and movement signals.

The term “activity-amount information” refers to quantitative measures of physical activity, including at least step counts, durations of movement, and estimated energy expenditure.

The term “short-term indicator” refers to a metric computed over a relatively short time window, including at least sitting duration, heart-rate variability, and changes in facial expression.

The term “state change” refers to a transition in user condition as detected by comparing current short-term indicators with previous values or thresholds.

The term “short prompt sentence” refers to a concise prompt sentence that focuses on short-term indicators for requesting a brief micro-intervention proposal from a generative artificial-intelligence model.

The term “micro-intervention” refers to a short, targeted action or suggestion intended to influence the user's condition in near real time, such as a brief break or breathing exercise.

The term “user-response history” refers to records of how the user interacted with or reacted to provided advice, including at least whether advice was viewed, ignored, followed, or rejected.

The term “learning process” refers to computational procedures that update model parameters or prompt-generation templates based on accumulated data, including at least retraining, fine-tuning, and parameter adjustment.

The term “prompt-sentence generation template” refers to a predefined or learned structure used by the processor to formulate prompt sentences from context information.

The term “predictive model” refers to any machine-learning model that outputs health-state information, emotion information, or related predictions from processed feature values.

The term “integrated computing architecture” refers to a system-level arrangement in which data acquisition, preprocessing, model inference, prompt generation, external communication, and learning are implemented in a coordinated and interdependent manner by the server.

In one embodiment, a server cooperates with one or more terminals to implement an AI-based health support system that executes the functions recited in the claims. The server includes at least one processor and at least one memory device. The processor executes programs stored in the memory device to perform data acquisition, preprocessing, model inference, prompt-sentence generation, external-service interaction, user-interface support, and learning operations. The memory device may be implemented as a relational database system, such as a database management system running on non-transitory semiconductor memory and magnetic storage.

The terminal is operated by a user and may be a smartphone, a tablet, a personal computer, smart glasses, or a wrist-worn device. The terminal executes an application that collects user inputs and sensor data, transmits the data to the server over a network, and presents outputs received from the server. The network may be the Internet, and communication between the terminal and the server may use HTTPS with TLS for encryption.

The user operates the terminal to register basic attribute information and activity information. The user inputs data such as target body weight, target physical condition, age, sex, weight, typical daily schedule, and self-reported preferences via graphical user-interface elements of the application. The terminal validates the input format (for example, checks for numeric ranges) and transmits the validated basic attribute information to the server in a structured format such as a JSON object.

The terminal further collects activity information that changes on a daily basis. The terminal obtains diet information by allowing the user to select food items from a list or to input free-text meal descriptions. The terminal obtains sleep information by recording bedtimes and wake times or by importing data from a platform-specific health service. The terminal obtains exercise information by reading step counts and activity durations from motion sensors or external applications. The terminal obtains biometric information such as heart rate and heart-rate variability from a wearable device via Bluetooth. The terminal obtains emotional-state information by presenting a mood-selection screen or a free-text comment box and by optionally capturing facial images in the case of smart glasses. The terminal transmits this activity information to the server at predetermined intervals or when a user submits new data. The server receives the basic attribute information and the activity information and stores them in the memory device. The server executes a data-preprocessing module implemented using numerical computation libraries, such as an array-processing library and a data-frame library, to convert the raw data into feature vectors suitable for machine-learning models. The server uses data structures such as tables “user_profile,” “activity_log,” “biometric_stream,” and “emotion log” to store normalized records. Each record is associated with a user identifier and a timestamp.

The server normalizes numerical information by applying scaling operations. For example, the server computes for each numeric feature x a standardized value (x−μ)/σ, where μ and σ are the mean and standard deviation computed from historical data. This normalization improves numerical conditioning for downstream neural-network inference and reduces sensitivity to arbitrary measurement scales. The server encodes categorical information such as sex, activity type, and device type using one-hot vectors or integer indices that are mapped to embedding vectors inside the neural networks. The server completes missing values using rule-based strategies, such as substituting a user-specific rolling mean for missing sleep durations, and model-based strategies, such as using a trained regression model to impute missing step counts from correlated features.

The server computes moving averages for key indicators. For example, the server maintains, for each user, a 7-day moving average of daily step counts, a 7-day moving average of sleep duration, and a 3-day moving average of energy intake. The server computes these moving averages incrementally, using ring buffers and cumulative sums stored in the memory device, in order to reduce computational load. The server thereby maintains exercise indicators, sleep indicators, and energy-intake indicators in an efficient, cache-friendly manner.

The server evaluates the user's health state using a machine-learning model. In one embodiment, the server uses a deep neural network implemented in a general-purpose machine-learning framework such as a tensor-based framework. The network may be a multi-layer perceptron (MLP) having an input layer corresponding to the feature vector (for example, age, sex embedding, BMI, rolling averages of steps, rolling averages of sleep duration, rolling averages of calories, and emotion scores), several fully connected hidden layers with rectified linear activation functions, and an output layer that produces continuous scores for exercise sufficiency, sleep sufficiency, and energy balance. The server trains this model offline using historical user data and supervised learning, minimizing a loss function such as a weighted sum of mean-squared error and cross-entropy with respect to labeled health states. The server updates model parameters by stochastic gradient descent or a variant such as Adam, and periodically deploys updated model checkpoints.

The server executes the trained machine-learning model for inference during runtime. The server loads the model parameters into memory and performs batch or mini-batch forward passes over incoming feature vectors. The server outputs health-state information, such as a value in [0,1] indicating under-exercise probability, a value in [0,1] indicating sleep-deficit probability, and a value in [0,1] indicating excessive energy intake. The server writes the health-state information into a table “health_state” linked to the corresponding time and user identifier.

The server computes emotion information using an emotion-analysis model. In one embodiment, the server applies a natural-language processing model to free-text comments and a separate classifier to facial-expression features. The server uses a text encoder that tokenizes the input and maps the tokens to embeddings, followed by a transformer-type encoder or recurrent neural network. The server passes the resulting text representation to a classification head that outputs emotion probabilities such as stress, joy, sadness, and calm. The server uses cross-entropy loss during training and backpropagation to learn parameters. For facial data, the server may use a convolutional neural network to extract features from facial images and classify them into basic emotion categories. The server fuses text-based and image-based scores, for example, by computing a weighted average according to model confidence levels, to generate a consolidated emotion-state vector. The server stores this emotion information in the memory device.

The server generates context information based on the health-state information and the emotion information. The server assembles a context object that includes: user profile attributes (for example, “35-year-old male, weight 80 kg”), target state (for example, “lose 5 kg”), calculated health-state indicators (for example, “underactive,” “sleep deficit,” “high energy intake”), and emotion state (for example, “stress 0.8”). The server also determines the advice type or types to be generated. For example, if exercise is insufficient and the user is stressed, the server selects exercise advice and relaxation advice as advice types and includes constraints such as maximum recommended daily exercise time and preferred exercise intensity.

The server converts the context information into a natural-language prompt sentence addressed to a generative AI model. The server uses prompt-generation templates stored in the memory device. Each template is a pattern with placeholders for context variables, such as “[AGE]-year-old [SEX], weight [WEIGHT] kg, goal [GOAL], average sleep [SLEEP_AVG] hours, activity level [ACTIVITY_STATE], emotion [EMOTION_STATE]. As a health coach, propose [ADVICE_SCOPE].” The server replaces the placeholders with concrete values. For example, the server may generate the following prompt sentence:

“User: 35-year-old male, weight 80 kg, target is to lose 5 kg. Average sleep: 5 hours per night. Activity: underactive, daily steps around 3,000. Emotion: high stress. As a health coach, propose a 7-day plan with light exercise, low-calorie high-protein meals, and daily relaxation routines.”

In a diet-focused case, the server may generate:

“Based on the following data: age 35, male, 80 kg, low daily steps (~3,000), goal is weight loss, high stress level. Propose a one-day low-calorie, high-protein meal plan including breakfast, lunch, dinner, and one snack, with brief descriptions.”

In a micro-intervention case, the server may generate:

“The user has been sitting for 2 hours, heart rate is slightly elevated, and emotion analysis indicates mild anxiety. In one or two sentences, propose a 5-minute activity that combines gentle movement and deep breathing.”

The server transmits the prompt sentence to a generative AI model via an application-programming interface over the network. The generative AI model may be an autoregressive language model, such as a transformer-based network, that receives the prompt sentence and generates a completion token by token. The server specifies generation parameters such as maximum output length, sampling temperature, and top-k or top-p values to control diversity and determinism. The generative AI model executes on a separate computing environment with dedicated accelerators.

The server receives the natural-language response from the generative AI model and parses the response. The server uses rule-based parsing or statistical parsing to identify sections such as “Exercise Plan,” “Diet Plan,” and “Relaxation Tips.” The server then converts the parsed segments into structured advice information. For the diet menu, the server extracts dish descriptions, meal times, and optional nutritional notes and stores them in a “diet advice” table. For the exercise content, the server extracts activity types (for example, walking, yoga), durations, weekly frequencies, and intensities and stores them in an “exercise_advice” table. For sleep guidelines and relaxation procedures, the server extracts recommended bedtime, pre-sleep routines, and breathing techniques and stores them in corresponding tables. The server records, for each advice instance, the original prompt sentence, the generative AI output, the parsed structured advice, and related context information in a “ai_interaction_log” table. This logging creates an auditable record of how prompt design and model responses influence user outcomes and later supports refinement of prompt-generation templates and training of new models.

The server integrates with an external delivery-service apparatus to operationalize diet advice. The server maintains a local representation of the external item catalog, including item identifiers, item names, textual descriptions, and estimated nutritional attributes. The server aligns each recommended dish from the diet menu with catalog items using a matching algorithm. For example, the server tokenizes the dish description into keywords, computes similarity scores against item descriptions using term-frequency-inverse-document-frequency measures or embedding-based cosine similarity, and filters items based on nutritional constraints inferred from the advice (such as “low-calorie” or “high-protein”). The server selects candidate delivery-target items with similarity scores exceeding a threshold and satisfying the nutritional constraints.

The server constructs order information using the matched items. The server creates an order payload including item identifiers, quantities, destination location stored in the user profile, desired delivery time, and payment token or payment reference. The server formats the payload according to the communication interface specification of the external delivery-service apparatus, such as REST over HTTPS with a defined JSON schema. The server transmits the payload and receives a response including order identifier, estimated delivery time, and status. The server stores this order information in an “order_log” table and associates it with the corresponding user and the advice that triggered the order. The terminal displays the advice information and order information received from the server. The terminal renders diet menus as readable meal cards, exercise plans as daily or weekly schedules, and relaxation procedures as stepwise instructions. The terminal shows order status updates such as “Order placed,” “Preparing,” “Out for delivery,” and “Delivered” based on messages or polling results from the server. The user may confirm, adjust, or reject suggested orders via the terminal interface.

The terminal also supports notifications and reminders. Upon receiving advice information that includes time-specific actions, the terminal schedules local alarms using an operating-system notification manager. For example, the terminal schedules a reminder at 20:00 for “evening walk 30 minutes” or a reminder before bedtime for a breathing exercise. This local scheduling reduces network dependence for time-critical alerts.

The system processes continuous biometric streams for micro-interventions. A wearable terminal, such as a smart watch or smart glasses, measures heart rate and motion continuously and periodically transmits buffered data to the server. The server stores the streaming data in a high-throughput structure optimized for time-series retrieval. The server computes short-term indicators, such as sitting duration (time without significant movement) and heart-rate variability (standard deviation of RR intervals), using sliding windows. The server compares these indicators to thresholds derived from population statistics and user-specific baselines. When the indicators exceed or fall below respective thresholds, the server determines that a state change has occurred.

Upon detecting a state change, the server generates a short prompt sentence including the short-term indicators and the emotion information. The examples above illustrate how the server concisely encodes context in natural language. The server sends this short prompt sentence to the generative AI model and receives a brief suggestion, such as:

“Stand up, stretch your arms overhead, and walk slowly around the room while taking 10 deep breaths.”

The server formats this suggestion as a micro-intervention notification and transmits it to the terminal. The terminal presents the suggestion immediately as an overlay or pop-up, optionally with a soft audio cue, enabling near real-time adaptation to the user's physiological state.

The server periodically or conditionally executes a learning process to improve models and prompt-generation templates. The server aggregates historical feature vectors, health-state labels, emotion labels, prompt sentences, advice information, and user-response history. The server defines training datasets where the input consists of feature vectors and context variables and the output consists of observed outcomes, such as whether a suggestion was followed or correlated changes in health indicators. The server retrains predictive models by minimizing loss functions that combine prediction error with regularization terms. The server also updates prompt-generation templates by analyzing which templates lead to higher adherence rates or more stable advice patterns. For example, the server adjusts the level of specificity in prompts regarding calorie ranges or exercise durations if data indicate that such specificity produces more actionable and consistent generative outputs.

The described architecture provides technical improvements in several respects. The server performs integrated, multi-stage preprocessing using specialized data structures (moving-average buffers, encoded feature vectors) and machine-learning pipelines, thereby reducing redundant computations and improving inference latency. The server utilizes normalization and feature engineering that are specifically tailored to health-related signals, which improves prediction accuracy of health-state and emotion-state classifiers compared to naive usage of raw logs. The server's prompt-sentence generation is not a static textual template; the server dynamically composes prompts from structured context and logs prompt-response pairs, allowing subsequent optimization and thereby improving the quality and stability of generative outputs.

Furthermore, the server couples high-level generative advice with low-level technical operations such as item-catalog matching and order-payload construction, integrating natural-language generation with transaction-oriented computing. This integration reduces communication overhead by avoiding repeated manual confirmations and separate search queries that a user or a conventional system would otherwise perform. By processing continuous biometric streams and generating micro-intervention prompts algorithmically based on short-term indicators, the system performs a type of adaptive control over user-facing feedback (for example, regulation of notification rate and content), which constitutes a technical improvement in how the computer system reacts to streaming sensor data. The server implements learning loops that alter internal model parameters and prompt templates based on logged interactions. This configuration allows the system to converge toward more efficient and accurate representations over time, improving computational efficiency (fewer false positives in micro-intervention triggers, fewer irrelevant menu matches) and reducing unnecessary network or processing load. These improvements arise from specific data structures, algorithms, and model-training strategies, rather than from mere automation of human mental processes.

Alternative embodiments may vary specific components while preserving the overall architecture. The server may replace the MLP health-state model with a temporal convolutional network or a recurrent neural network to better capture temporal dependencies. The server may replace the transformer-based language model with any generative AI model capable of conditional natural-language generation. The emotion-analysis model may rely solely on text, solely on biometric time series, or on multimodal fusion, depending on available sensors. The catalog-matching algorithm may use different similarity measures or may employ a learned embedding space trained via contrastive learning. The short-term indicator thresholds may be adapted per-user or derived from population statistics. In each case, the server, the terminal, and the user cooperate through the described data flows to implement the claimed system, and variations in specific algorithms or model architectures remain within the scope of the described embodiments.

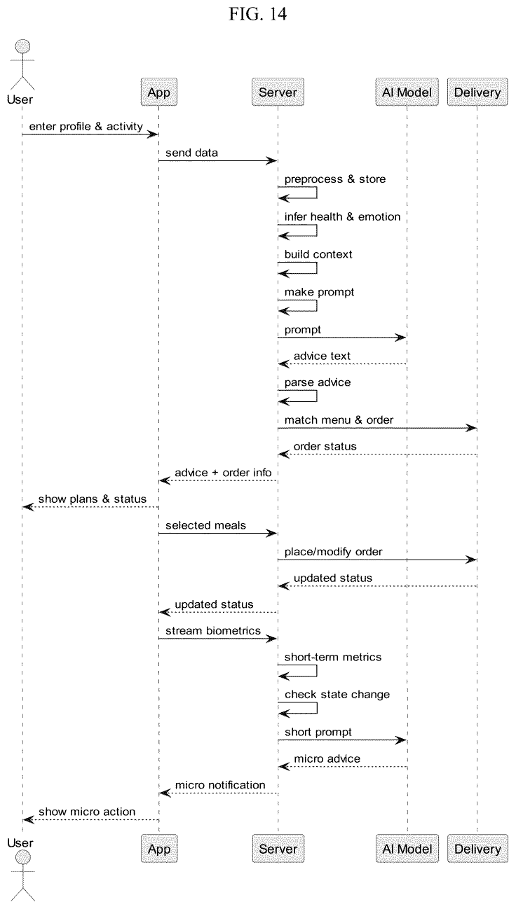

The following describes the processing flow using FIG. 14.

### Step 1:

User operates the terminal to input basic attribute information and activity information. User enters target state, age, sex, weight, and optional preferences through input forms, and records activity information such as meals, sleep times, exercise sessions, mood selections, and comments. The input is the raw user entries (text, numbers, selections), and the output is a structured data object in the terminal (for example, a key-value map representing the profile and daily activities).

### Step 2:

Terminal validates and transmits user data to the server.

Terminal checks that numeric fields (age, weight, sleep hours) are within allowable ranges, that mandatory fields are not empty, and that formats (dates, times) are correct. The input is the structured data object from Step 1, and the output is a serialized payload (for example, JSON) sent via HTTPS to the server. The terminal additionally attaches device identifiers and timestamps before transmission.

### Step 3:

Server receives and stores the transmitted data.

Server parses the received payload, verifies integrity (for example, checksum or schema validation), and associates the data with an internal user identifier. The input is the serialized payload from the terminal, and the output is a set of database records written into tables such as a user profile table, an activity log table, a biometric stream table, and an emotion log table. The server performs data insertion operations and commits the transaction so that the data become persistent.

### Step 4:

Server performs data-preprocessing to generate feature values.

Server reads the newly stored records from the memory device, aggregates them with recent history, and applies numerical and categorical transformations. The input is raw profile and activity records (for example, daily steps, sleep intervals, caloric estimates, mood labels), and the output is a feature vector for each user and time segment. The server computes moving averages (for example, 7-day average steps), normalizes numerical values (for example, z-score scaling), encodes categories (for example, one-hot vectors for sex and exercise types), and imputes missing values with rules or model-based estimates.

### Step 5:

Server infers health-state information using a machine-learning model.

Server loads a trained neural network (for example, a multi-layer perceptron) into memory and performs a forward pass with the feature vector. The input is the feature vector from Step 4, and the output is health-state information, such as probabilities or scores for under-exercise, sleep deficit, and excessive energy intake, along with possible recommended ranges for steps, exercise minutes, or caloric intake. The server executes matrix multiplications and activation functions to compute these outputs and stores them in a health-state table.

### Step 6:

Server infers emotion information using an emotion-analysis model.

Server retrieves emotion-related data, including free-text comments, mood selections, and biometric metrics, and applies one or more classifiers. The input is a combination of text sequences and biometric indicators associated with the current period, and the output is emotion information, including labels (for example, stress, joy, anxiety) and intensity scores or confidence values. The server tokenizes text, encodes it into embeddings, runs it through a neural network, optionally combines it with biometric classifications, and writes the consolidated emotion data into an emotion-state table.

### Step 7:

Server generates context information for advice creation.

Server collects relevant user profile data, recent feature values, health-state information, and emotion information, and organizes them into a structured context object. The input is a set of records from the profile table, feature table, health-state table, and emotion-state table for a given user, and the output is context information that specifies advice types (for example, diet, exercise, sleep, relaxation) and constraints (for example, time budget, food preferences). The server evaluates simple rules (for example, “if under-exercise and high stress, include relaxation and light exercise”) and assembles all parameters needed to form a detailed description of the user's current state.

### Step 8:

Server constructs a prompt sentence for a generative AI model.

Server loads a prompt-generation template and fills placeholders with values from the context information. The input is the context information from Step 7, and the output is a prompt sentence in natural language describing the user and requesting specific advice from the generative AI model. The server performs string substitutions and concatenations to embed items such as age, sex, weight, target state, average sleep, activity levels, and emotional state into the template. For example, the server may generate:

“User: 35-year-old male, weight 80 kg, target is to lose 5 kg. Average sleep: 5 hours per night. Activity: underactive, daily steps around 3,000. Emotion: high stress. As a health coach, propose a 7-day plan with light exercise, low-calorie high-protein meals, and daily relaxation routines.”

### Step 9:

Server queries the generative AI model with the prompt sentence.

Server sends the prompt sentence to the generative AI model via an API and awaits the generated response. The input is the text of the prompt sentence from Step 8, and the output is a natural-language response created by the generative AI model. The server sets parameters such as maximum length and randomness and transmits the prompt, then receives a text stream or complete string and buffers it for further processing.

### Step 10:

Server parses the natural-language response into structured advice information. Server analyzes the generated text to identify sections and extract actionable elements. The input is the natural-language response from Step 9, and the output is structured advice information divided into components such as diet menus, exercise plans, sleep guidelines, and relaxation procedures. The server applies pattern matching, regular expressions, and simple natural-language parsing to detect headings and bullet-like segments, converts them into database-ready records (for example, meal entries with names and times), and stores them in advice tables.

### Step 11:

Server matches diet advice with external delivery-service catalog items.

Server processes each recommended dish in the diet menu and compares it with items in a catalog obtained from a delivery-service apparatus. The input is the set of dish descriptions from the diet portion of the advice information and a local representation of the external catalog, and the output is a mapping from each dish to one or more candidate catalog item identifiers. The server tokenizes dish names, computes similarity scores based on textual and nutritional attributes, filters results using constraints (for example, “low-calorie,” “high-protein”), and selects items whose scores exceed thresholds.

### Step 12:

Server constructs and transmits order information to the delivery-service apparatus. Server prepares an order payload including selected catalog item identifiers, quantities, user address, and desired delivery time. The input is the mapping of dishes to catalog items from Step 11 and stored user profile information (address, payment token), and the output is an order request sent to the external delivery-service apparatus and a confirmation record stored locally. The server formats the payload according to the external API specification, sends it via HTTPS, receives a response with order identifier and estimated delivery time, and inserts this information into an order log table.

### Step 13:

Server logs prompt-response pairs and advice history.

Server records the prompt sentences, generative AI responses, and structured advice, along with associated health-state and emotion-state information, for later analysis. The input is the prompt sentence from Step 8, the natural-language response from Step 9, and the parsed advice information from Step 10, and the output is a set of history records inserted into an interaction log table. The server tags each record with timestamps, model version identifiers, and user identifiers, enabling future correlation and model improvement.

### Step 14:

Server transmits advice information and order information to the terminal.

Server prepares a response message that summarizes the advice and any active orders for a given user. The input is the structured advice records from Step 10 and the order records from Step 12, and the output is a serialized message (for example, JSON) sent to the terminal. The server selects relevant fields (for example, today's meals, planned exercises, current order status), formats them to match the terminal's interface requirements, and sends the message over the existing secure connection or via a push-notification service.

### Step 15:

Terminal presents advice and order status to the user.

Terminal receives the server's response and updates its user interface accordingly. The input is the serialized message from Step 14, and the output is a set of rendered screens or notifications that the user can view and interact with. The terminal parses the message, populates view components (for example, cards for meals and exercises, progress bars for orders), and may schedule local notifications for time-specific activities.

### Step 16:

User selects and confirms recommended meals for ordering.

User browses the recommended meals displayed by the terminal and chooses one or more items to order. The input is the rendered diet advice and available options from Step 15, and the output is a user selection captured by the terminal (for example, a list of chosen items and desired delivery times). The user may modify quantities or exclude certain dishes before confirming the selection.

### Step 17:

Terminal sends user selections back to the server for final order processing.

Terminal packages the confirmed selections and sends them to the server. The input is the list of selected items and preferences from Step 16, and the output is an updated order request message transmitted to the server. The terminal may include additional metadata such as a preferred delivery window or special instructions.

### Step 18:

Server refines order information and updates or creates orders.

Server receives the user selection and either updates an existing order or creates a new one. The input is the selection message from Step 17, along with existing catalog mappings and profile data, and the output is revised or new order information, which is sent to the delivery-service apparatus and recorded in the order log. The server validates availability, re-checks nutritional constraints if necessary, and then performs the same formatting and transmission steps as in Step 12.

### Step 19:

Terminal tracks and displays real-time order updates.

Terminal periodically requests status updates from the server or receives push notifications. The input is status messages that carry order state changes (for example, “preparing,” “out for delivery”), and the output is an updated display of order progress for the user. The terminal changes icons, texts, and timelines to reflect the latest information.

### Step 20:

Terminal collects continuous biometric and activity data for micro-interventions.

Terminal (including wearable components) measures heart rate, motion, and other biometric signals at regular intervals and aggregates them into small time windows. The input is raw sensor signals sampled by device hardware, and the output is a compressed or summarized data block (for example, sequences of heart-rate values and step counts) that is sent to the server in the background.

### Step 21:

Server analyzes short-term indicators and detects state changes.

Server receives the streaming biometric blocks and computes short-term features. The input is the recent biometric and activity-amount data from Step 20, and the output is a determination of whether a state change (for example, prolonged sitting, elevated stress) has occurred. The server calculates indicators such as sitting duration from motion patterns and heart-rate variability from beat-to-beat intervals, compares them to thresholds or historical baselines, and flags conditions that require micro-intervention.

### Step 22:

Server generates short prompt sentences for micro-interventions.

Server constructs concise natural-language descriptions of the short-term context to query the generative AI model. The input is the set of short-term indicators and current emotion information from Step 21 and the emotion-state table, and the output is a short prompt sentence specifically requesting a brief, actionable suggestion. The server uses a compact template to express the current physiological and emotional situation and the desired intervention length, such as:

“The user has been sitting for 2 hours, heart rate is slightly elevated, and emotion analysis indicates mild anxiety. In one or two sentences, propose a 5-minute activity that combines gentle movement and deep breathing.”

### Step 23:

Server obtains micro-intervention suggestions from the generative AI model.

Server sends the short prompt sentence to the generative AI model and receives a short response designed for immediate action. The input is the short prompt sentence from Step 22, and the output is a brief natural-language suggestion, such as “Stand up, stretch your arms overhead, and walk slowly around the room while taking 10 deep breaths.” The server stores this suggestion temporarily and may also log it as part of the interaction history.

### Step 24:

Server delivers micro-intervention notifications to the terminal.

Server formats the micro-intervention suggestion as a notification payload and transmits it to the terminal. The input is the text of the suggestion from Step 23 and user identification and priority information, and the output is a push or in-app notification arranged for immediate display. The server may set flags indicating that the notification should override less urgent alerts.

### Step 25:

Terminal presents micro-intervention suggestions to the user in real time.

Terminal receives the notification and shows it promptly, possibly overlaying it on top of other content or presenting it in the user's field of view on a wearable. The input is the notification payload from Step 24, and the output is the visible or audible presentation of the action steps to the user. The terminal may log whether the user acknowledges or dismisses the notification.

### Step 26:

Server updates models and prompt-generation templates using accumulated history. Server periodically consolidates interaction logs, health-state records, emotion-state records, and user-response histories to refine internal models and template parameters. The input is the historical data stored in the memory device (prompt sentences, model outputs, advice follow-through signals, biometric trends), and the output is updated model parameters and updated prompt-generation templates. The server executes training jobs that recompute weights of predictive models and adjusts how prompts are formed (for example, adding or removing context details), and then deploys the new configurations for future inference and prompt-sentence generation.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

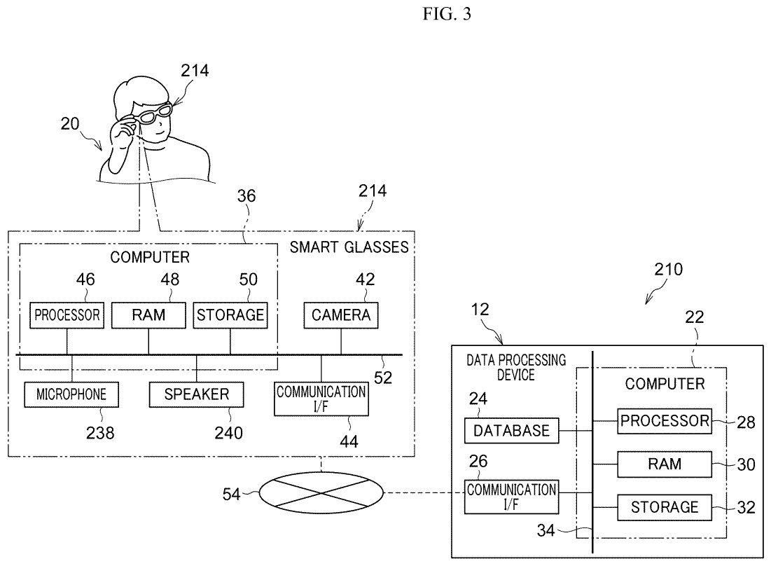

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

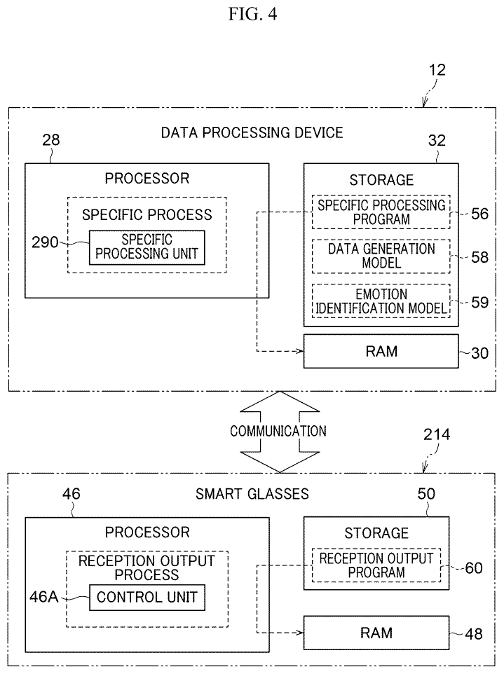

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

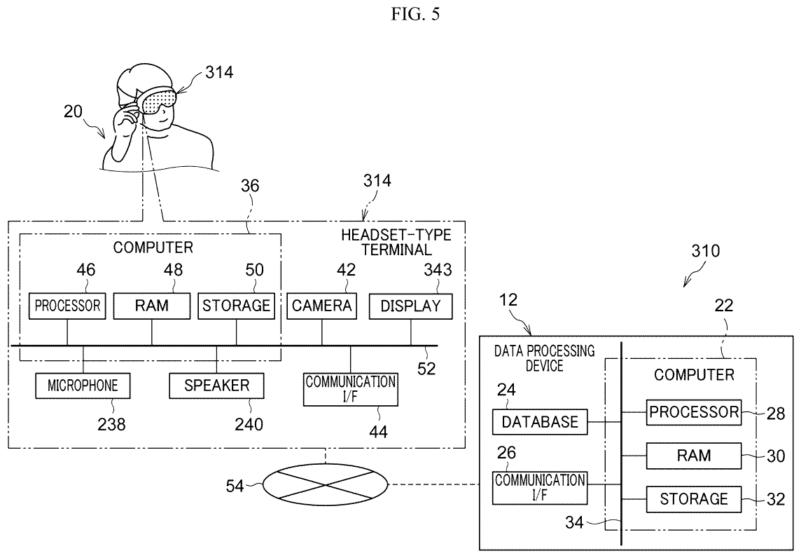

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

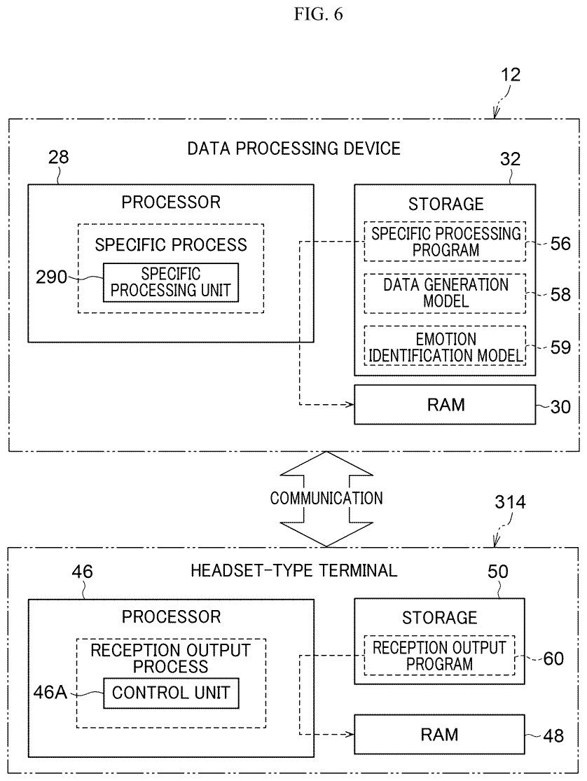

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

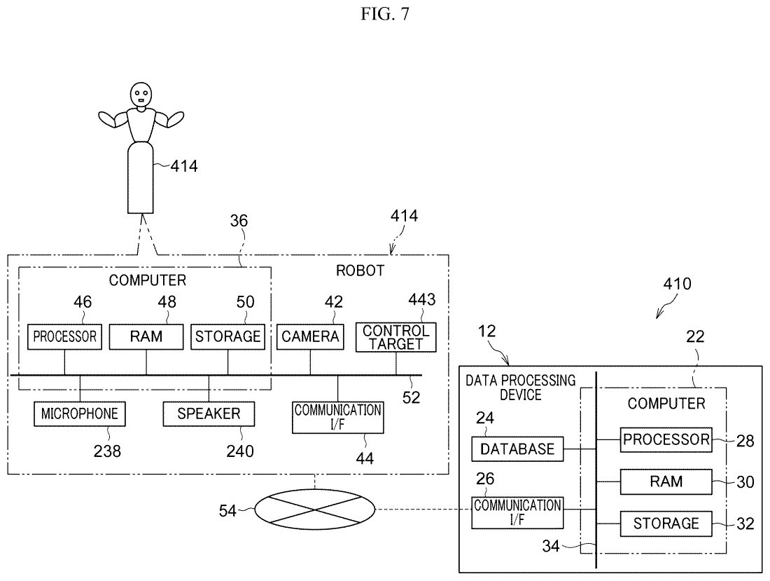

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

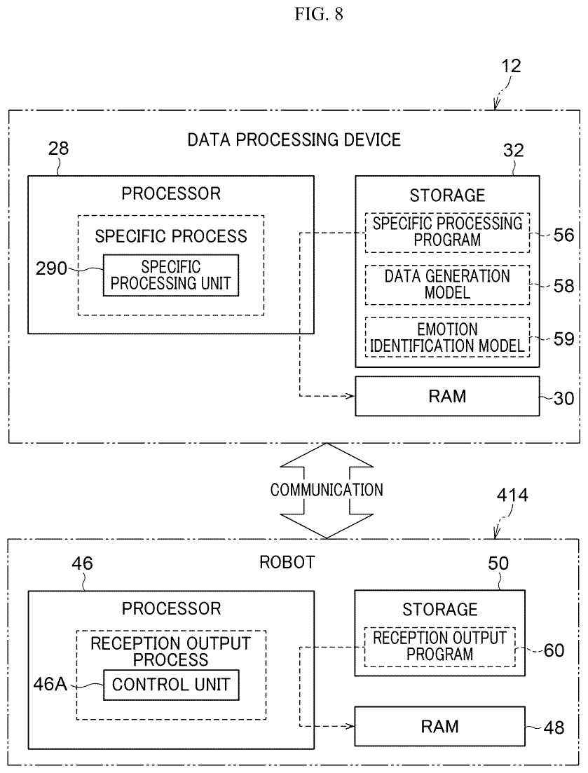

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

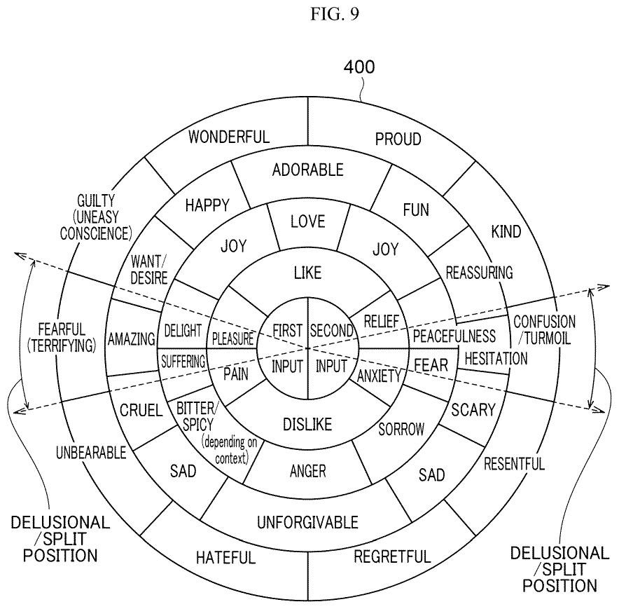

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

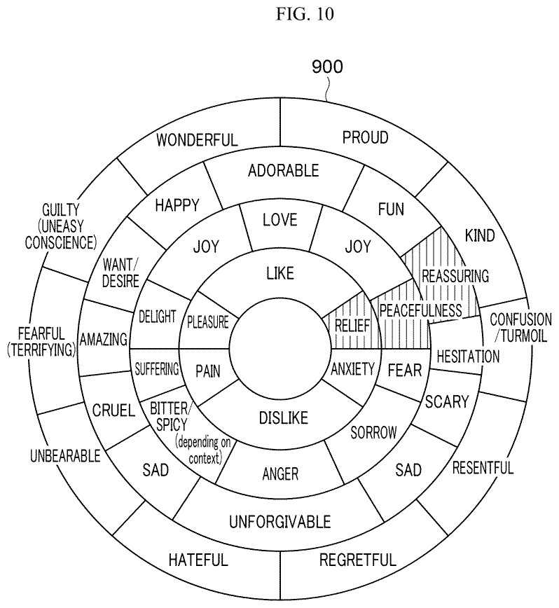

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, via a communication path from an information processing terminal operated by a user, basic attribute information of the user including a target state, age, sex, weight and the like, and behavior information that varies on a daily basis including meal information, sleep information, physical activity information, emotional state information and the like, and to store the acquired attribute information and the behavior information as structured data in an information storage region of a recording device while maintaining an association that allows identification of an update history of the behavior information, and
analyze, based on the attribute information and the behavior information stored in the information storage region, a health state of the user over time, aggregate the behavior information to calculate indicator information including at least an average sleep time, an activity frequency, and an eating tendency, generate as a prompt sentence a descriptive text expressed in natural language including the attribute information, the indicator information, and the target state of the user, and incorporate into the prompt sentence constraint conditions and an output format that instruct a generative AI model to perform evaluation of the health state and creation of a concrete behavioral plan toward a healthy state, thereby generating input data for the generative AI model, and
input the prompt sentence to the generative AI model, obtain, through natural language generation processing by the generative AI model, a response sentence including health-related advice information individually adapted to the attribute information, the behavior information, and the target state of the user, divide the response sentence into a plurality of category pieces including proposals relating to meals, proposals relating to physical activity, proposals relating to sleep, and proposals relating to the emotional state, add metadata to the category pieces, store the category pieces as history information in the information storage region, and transmit the category pieces as machine-readable data to the information processing terminal, and
analyze, based on the emotional state information included in the behavior information and content of the response sentence, an emotional tendency of the user using an emotional processing mechanism that performs emotion estimation processing, and change input data to be requested from the generative AI model by adjusting, according to an analysis result, instruction content and expression intensity in the prompt sentence so as to request from the generative AI model health-related advice information having different tones including at least encouragement-oriented advice and warning-oriented advice, and
acquire, from the information processing terminal, update content of the behavior information and operation information relating to an implementation status of the advice by the user, additionally record the update content and the operation information in the information storage region, regenerate the prompt sentence according to the update content, and iteratively and individually optimize the health-related advice information generated by the generative AI model.

### (Supplementary 2)

The system according to supplementary 1,
wherein the processor is configured to
analyze the behavior information stored in the information storage region, and, when a sleep time shorter than a predetermined threshold is detected consecutively, generate the prompt sentence with additional content that instructs the generative AI model to output dietary management advice including proposals regarding adjustment of energy intake and selection of foods for the purpose of suppressing an increase in appetite accompanying sleep deprivation.

### (Supplementary 3)

The system according to supplementary 1,
wherein the processor is configured to
calculate a physical activity frequency, a physical activity intensity, and an activity amount of the user from the behavior information stored in the information storage region, and generate the prompt sentence such that the prompt sentence incorporates content that instructs the generative AI model to output advice regarding an activity plan including an activity amount, an activity type, and an implementation schedule, based on a relationship between the calculation result and the target state of the user.

### Application Example 1

### (Supplementary 1)

A system comprising a processor,
wherein the processor is configured to
receive, from a terminal, as input, basic attribute information including a target health state of a user, age, sex, and physical characteristics, and lifestyle activity information including meals, sleep, exercise, and emotional state, and to store the input information as structured data in a storage medium,
perform statistical processing and feature generation processing on the stored basic attribute information and lifestyle activity information, and calculate a nutrition index and an exercise index for the user,
generate a prompt sentence written in natural language, the prompt sentence including the calculated nutrition index and exercise index and the basic attribute information and the lifestyle activity information, and input the prompt sentence to a generative AI model so as to cause the generative AI model to generate advice information including a meal plan and an exercise plan according to a health state of the user,
analyze the emotional state included in the lifestyle activity information by using an emotion analysis algorithm, and reflect an analysis result of the emotional state in the prompt sentence so as to cause the generative AI model to generate advice information including expressions and contents corresponding to the emotional state of the user,
analyze the advice information acquired from the generative AI model to extract a meal plan including nutrient composition information, and associate the meal plan with item information of an external article providing service so as to generate selectable meal options for ordering, and
transmit the selectable meal options and the exercise plan to the terminal, receive selection operations and feedback information from the user via the terminal, store a selection history and the feedback information in the storage medium, and reflect the selection history and the feedback information in generation of a next prompt sentence and generation of subsequent advice information.

### (Supplementary 2)

The system according to supplementary 1,
wherein the processor is configured to
include, in the prompt sentence and in generation of the advice information, condition information that instructs the generative AI model to generate a meal plan having a nutrient composition and an energy intake amount for suppressing an increase in appetite, when a sleep time of the user is shorter than a predetermined value.

### (Supplementary 3)

The system according to supplementary 1,
wherein the processor is configured to
calculate, in the statistical processing and the feature generation processing, an exercise load index from lifestyle activity information including an exercise type, an exercise time, and an exercise frequency of the user, and describe the exercise load index in the prompt sentence so as to instruct the generative AI model to generate an exercise plan for proposing an exercise amount and an exercise type suitable for the user.

### Example 2

### (Supplementary 1)

A system comprising a processor,
wherein the processor is configured to
acquire, via a terminal device, attribute information of a user including a target state, age, sex, body weight and the like, and time-series state information including meal information, sleep information, physical activity information, psychological state information and the like, store the acquired attribute information and time-series state information in a storage area of a storage device, and generate, for each user, aggregated information including a history of the time-series state information,
perform numerical computation processing and statistical processing based on the aggregated information to extract feature values including index values of sleep amount, physical activity amount, eating habits and temporal change amounts thereof, input the feature values to an evaluation model using a machine learning algorithm, and generate analysis result data indicating a health risk of the user and lifestyle items requiring improvement,
generate, based on the analysis result data, the attribute information and the time-series state information, a prompt sentence to be input to a generative artificial intelligence model, the prompt sentence describing the analysis result data in a natural language and including conditions relating to a target field of advice content, an expression style, a level of detail and a period plan of output from the generative artificial intelligence model,
input the prompt sentence to the generative artificial intelligence model, obtain a health-related advice text in a natural language from the generative artificial intelligence model, and format the health-related advice text while associating the health-related advice text with the analysis result data, to generate advice information including summary information, specific action items and key improvement areas,
estimate an emotional state of the user using an emotion estimation processing unit, classify the emotional state based on the psychological state information included in the time-series state information and subjective input information of the user acquired from the terminal device, and adjust at least one of the expression style in the prompt sentence and a load level of recommended actions in accordance with the emotional state so as to personalize the advice text output from the generative artificial intelligence model, and
transmit the generated advice information to the terminal device, and control the terminal device such that the summary information, the specific action items and the key improvement areas are displayed in a hierarchical manner and an execution status input by the user is accumulated again in the storage device as the time-series state information.

### (Supplementary 2)

The system according to supplementary 1,
wherein the processor is configured to, when it is determined based on the time-series state information that the sleep amount of the user is less than a predetermined threshold, include in the prompt sentence a risk index relating to eating behavior calculated by the evaluation model and feature values relating to eating habits of the user, and thereby generate the prompt sentence that instructs the generative artificial intelligence model to generate specific proposals concerning meal contents and intake timing for suppressing appetite that may increase due to sleep shortage.

### (Supplementary 3)

The system according to supplementary 1,
wherein the processor is configured to quantify a level and a temporal change of a physical activity amount of the user based on the time-series state information, use, together with the attribute information including the age, sex and body weight, a physical inactivity risk index calculated by the evaluation model, and thereby generate the prompt sentence that instructs the generative artificial intelligence model to generate an exercise plan including an exercise intensity, an exercise frequency and an exercise type that are adapted to the user.

### Application Example 2

### (Supplementary 1)

A system comprising a memory device configured to store user information, and a processor configured to access the memory device,
wherein the processor is configured to
receive, as input, basic attribute information of a user including at least a target state, age, sex, and weight, and activity information that varies on a daily basis including at least diet information, sleep information, exercise information, emotional-state information, biometric information, and behavior-history information, validate the input, and store the validated input in a plurality of information storage regions of the memory device in association with a user identifier,
execute data-preprocessing on the basic attribute information and the activity information stored in the memory device by performing at least normalization of numerical information, encoding of categorical information, completion of missing values, calculation of moving averages over a plurality of days, and generation of feature values including at least exercise-amount indicators, sleep indicators, and energy-intake indicators, and estimate a health state of the user by using a machine learning model based on the generated feature values, thereby generating health-state information representing the estimated health state,
execute an emotion-analysis model by using, as input, at least a subset of the activity information related to emotion and at least one of text information and biometric information, and generate emotion information representing an emotional state of the user and an intensity of the emotional state, generate context information relating to a type of advice and content of advice, the type of advice including at least one of diet advice, exercise advice, sleep advice, mood-adjustment advice, and micro-break advice, based on the health-state information and the emotion information, and convert the context information into a natural-language description to generate a prompt sentence for input to a generative artificial-intelligence model,
transmit the prompt sentence to the generative artificial-intelligence model disposed externally or internally to the system, receive a natural-language response from the generative artificial-intelligence model, analyze the natural-language response to generate advice information including at least one of an action plan toward a healthier state, a diet menu, exercise content, sleep guidelines, and relaxation procedures, and store the advice information and the prompt sentence in the memory device as history information,
associate information relating to the diet menu included in the advice information with item information provided by an external delivery-service apparatus by selecting delivery-target items based on at least dish names, nutritional characteristics, and energy amounts that constitute the diet menu, generate order information compatible with a communication interface of the external delivery-service apparatus, transmit the order information to the external delivery-service apparatus to execute an order process, and store a result of the order process as order information in the memory device,
transmit the advice information and the order information to a user terminal including at least one of a portable information terminal, a display device, and a wearable terminal, and enable, on the user terminal, at least display of the advice information, audio output of the advice information, setting of notification schedules based on the advice information, and display of progress status based on the order information,
analyze continuous biometric information or activity-amount information acquired as the activity information at predetermined intervals, detect a state change of the user based on short-term indicators including at least one of sitting duration, heart-rate variability, and facial-expression change, when the state change satisfies a predetermined condition, dynamically generate a short prompt sentence including the short-term indicators in the context information, obtain a short-time action proposal from the generative artificial-intelligence model based on the short prompt sentence, and transmit the short-time action proposal to the user terminal as a notification for micro-intervention, and
execute, periodically or conditionally, a learning process to update at least one of the machine learning model and a prompt-sentence generation process, based on the activity information, the health-state information, the emotion information, the prompt sentences, the advice information, and user-response history accumulated in the memory device.

### (Supplementary 2)

The system according to supplementary 1,
wherein the processor is configured to
determine a sleep-deficiency state by using the machine learning model based on sleep-time information included in the activity information, and, when the sleep-deficiency state is determined and appetite increase or fatigue is detected based on the emotion information, generate, as the prompt sentence, a prompt sentence that includes at least the sleep-time information, the weight, an energy-intake indicator, and the emotion information in the context information and instructs the generative artificial-intelligence model to generate a diet plan configured to suppress increased appetite while maintaining or improving the health state.

### (Supplementary 3)

The system according to supplementary 1,
wherein the processor is configured to
classify an exercise state by using the machine learning model based on at least step-count information, exercise-time information, and heart-rate information included in the activity information, determine at least one of an under-exercise state, an over-exercise state, and an appropriate-exercise state, generate, as the prompt sentence, a prompt sentence that instructs the generative artificial-intelligence model to generate an exercise proposal including at least exercise frequency, exercise intensity, exercise time, and exercise type based on a result of the determination and the emotion information, and provide, to the user terminal, the exercise proposal obtained from the generative artificial-intelligence model as a part of the advice information.

What is claimed is:

1. A system comprising:
circuitry configured to:
acquire, via a communication interface coupled to a packet-switched network, first data comprising static attribute parameters and second data comprising time-varying behavioral parameters transmitted from a terminal device;
store the first data and the second data in a storage device as structured time-stamped records;
compute indicator values from the second data by aggregating the time-varying behavioral parameters over a predetermined time window;
construct a prompt data structure comprising the first data, the indicator values, and constraint conditions conforming to a predefined template, and transmit the prompt data structure to a generative neural network model to obtain response data comprising recommendation elements;
apply an emotion analysis model to the second data to determine an emotional state, and adjust at least one of content and expression intensity of the recommendation elements on the basis of the determined emotional state; and
transmit the adjusted recommendation elements to the terminal device via the packet-switched network.

2. The system according to claim 1, wherein the static attribute parameters comprise at least a target state parameter, an age parameter, a sex parameter, and a weight parameter of a user, and wherein the time-varying behavioral parameters comprise at least diet information, sleep information, exercise information, and emotional state information that are updated on a daily basis.

3. The system according to claim 2, wherein the circuitry is configured to store each instance of the time-varying behavioral parameters in the storage device with a timestamp and an association identifier that links the instance to a corresponding user record, and maintain an update history that tracks changes to the time-varying behavioral parameters over successive time periods.

4. The system according to claim 3, wherein the circuitry is configured to compute the indicator values by calculating at least an average sleep duration over the predetermined time window, an activity frequency representing a count of exercise sessions within the predetermined time window, and an eating tendency derived from nutritional composition data extracted from the diet information.

5. The system according to claim 4, wherein the circuitry is configured to detect that the average sleep duration is below a predetermined threshold and, in response, include in the prompt data structure an instruction that causes the generative neural network model to generate a recommendation element comprising a dietary adjustment for suppressing increased appetite associated with reduced sleep.

6. The system according to claim 1, wherein the circuitry is configured to construct the prompt data structure by embedding, in a natural language template, the first data, the indicator values, a target state derived from the static attribute parameters, and explicit output format instructions that specify a structure of the response data, such that the generative neural network model generates the recommendation elements in a categorized format comprising separate sections.

7. The system according to claim 6, wherein the circuitry is configured to segment the response data received from the generative neural network model into a plurality of categorized recommendation elements with associated metadata, store the categorized recommendation elements as history records in the storage device, and use at least a portion of the history records as context data when constructing a subsequent prompt data structure.

8. The system according to claim 7, wherein the circuitry is configured to receive feedback data from the terminal device indicating an implementation status of previously transmitted recommendation elements, and dynamically adjust the constraint conditions and the expression intensity in a subsequent prompt data structure on the basis of the feedback data, the update history, and the determined emotional state, thereby iteratively optimizing the recommendation elements generated by the generative neural network model.

9. The system according to claim 1, wherein the emotion analysis model comprises a neural network that receives feature data derived from the second data and outputs a probability distribution over a plurality of emotion categories, and wherein the circuitry is configured to select the emotional state corresponding to a highest probability among the plurality of emotion categories.

10. The system according to claim 9, wherein the emotion categories are arranged according to an emotion map that positions emotions along dimensions corresponding to valence and arousal, and wherein the circuitry is configured to map the emotional state to a coordinate on the emotion map and derive the adjustment to the expression intensity from a region of the emotion map corresponding to the coordinate.

11. The system according to claim 10, wherein the circuitry is configured to, when the emotional state corresponds to a negative valence region on the emotion map, modify the prompt data structure to include an instruction that causes the generative neural network model to generate recommendation elements using encouraging language and reduced directive intensity, and when the emotional state corresponds to a positive valence region, modify the prompt data structure to include an instruction that causes the generative neural network model to generate recommendation elements using motivational language with increased specificity.

12. The system according to claim 1, wherein the circuitry is configured to analyze the response data to extract a first recommendation subset comprising a meal plan including nutrient composition information and a second recommendation subset comprising an exercise plan including activity type and duration parameters.

13. The system according to claim 12, wherein the circuitry is configured to associate elements of the meal plan with item identifiers of an external service provider by matching the nutrient composition information against a catalog stored in the storage device, and generate selectable options that the terminal device presents to the user for ordering, and to store a selection history indicating which selectable options the user selected and reflect the selection history in a subsequent prompt data structure.

14. The system according to claim 1, wherein the circuitry is configured to perform statistical processing on the second data stored in the storage device to compute a nutrition index representing a balance of macronutrient intake and an exercise index representing an intensity and regularity of physical activity, and include the nutrition index and the exercise index in the prompt data structure transmitted to the generative neural network model.

15. The system according to claim 14, wherein the circuitry is configured to compute a caloric balance by comparing an estimated caloric intake derived from the diet information against an estimated caloric expenditure derived from the exercise information and a basal metabolic rate calculated from the static attribute parameters, and include the caloric balance in the prompt data structure as an additional constraint condition.

16. The system according to claim 1, wherein the terminal device comprises at least one of a smart device having a display and a touch panel, smart glasses having a speaker and a microphone, a headset-type terminal having a display and a speaker, and a robot having a speaker and a motor-driven control target, and wherein the circuitry is configured to format the adjusted recommendation elements in a presentation format corresponding to an output capability of the terminal device.

17. The system according to claim 16, wherein the circuitry is configured to generate a time-series visualization data structure from the indicator values and the history records stored in the storage device, the time-series visualization data structure representing a trend of the time-varying behavioral parameters over a plurality of time windows, and transmit the time-series visualization data structure to the terminal device for rendering as a graphical display.

18. A system comprising:
circuitry configured to:
acquire, via a communication interface coupled to a packet-switched network, first data comprising static attribute parameters including at least a target state, an age, a sex, and a weight, and second data comprising time-varying behavioral parameters including at least diet information, sleep information, exercise information, and emotional state information, transmitted from a terminal device;
store the first data and the second data in a storage device as structured time-stamped records with an update history;
compute indicator values by calculating at least an average sleep duration, an activity frequency, and an eating tendency from the second data over a predetermined time window, and compute a nutrition index and an exercise index by performing statistical processing on the second data;
construct a prompt data structure by embedding the first data, the indicator values, the nutrition index, the exercise index, and a target state into a natural language template that includes constraint conditions and output format instructions, and transmit the prompt data structure to a generative neural network model comprising a Transformer-based architecture that predicts output tokens via softmax probability computation to obtain response data comprising categorized recommendation elements;
apply an emotion analysis model comprising a neural network classifier that maps feature data derived from the second data to a probability distribution over emotion categories arranged on an emotion map with valence and arousal dimensions, determine an emotional state, and adjust at least one of content and expression intensity of the categorized recommendation elements on the basis of the determined emotional state;
segment the response data into a plurality of categorized recommendation elements with associated metadata and store the categorized recommendation elements in the storage device as history records; and
transmit the adjusted categorized recommendation elements to the terminal device via the packet-switched network.

19. The system according to claim 18, wherein the circuitry is configured to receive feedback data from the terminal device indicating an implementation status of previously transmitted recommendation elements, and dynamically adjust the constraint conditions and the expression intensity in a subsequent prompt data structure on the basis of the feedback data and the update history, and wherein the circuitry is configured to extract a meal plan from the categorized recommendation elements and associate elements of the meal plan with item identifiers of an external service provider for generating selectable ordering options transmittable to the terminal device.

20. A method performed by circuitry of a server coupled to a packet-switched network via a communication interface, the method comprising:
acquiring, via the communication interface, first data comprising static attribute parameters and second data comprising time-varying behavioral parameters transmitted from a terminal device;
storing the first data and the second data in a storage device as structured time-stamped records;
computing indicator values from the second data by aggregating the time-varying behavioral parameters over a predetermined time window;
constructing a prompt data structure comprising the first data, the indicator values, and constraint conditions conforming to a predefined template, and transmitting the prompt data structure to a generative neural network model to obtain response data comprising recommendation elements;
applying an emotion analysis model to the second data to determine an emotional state, and adjusting at least one of content and expression intensity of the recommendation elements on the basis of the determined emotional state; and
transmitting the adjusted recommendation elements to the terminal device via the packet-switched network.
